(19) United States
(12) Patent Application Publication
(10) Pub. No.: US 2026/0292212 A1
(43) Pub. Date: Sep. 24, 2026

(54) ASYMMETRIC FRAME RATE CODING OF REGIONS OF INTEREST

(71) Applicant: Nokia Technologies Oy, Espoo (FI)

(72) Inventors: Miska Matias HANNUKSELA, Tampere (FI); Francesco CRICRÌ, Tampere (FI); Honglei ZHANG, Tampere (FI)

(21) Appl. No.: 19/474,006

(22) PCT Filed: Mar. 8, 2024
(86) PCT No.: PCT/IB2024/052259

§ 371 Date: Oct. 9, 2025

Related U.S. Application Data
(60) Provisional application No. 63/497,071, filed on Apr. 19, 2023.

(51) Int. Cl. H04N 19/172; H04N 19/117; H04N 19/167; H04N 19/70

(52) U.S. Cl. CPC H04N 19/172; H04N 19/117; H04N 19/167; H04N 19/70

(57) ABSTRACT

Various embodiments describe an apparatus, a method, and a computer program product. An example apparatus includes at least one processor; and at least one non-transitory memory storing instructions that, when executed by the at least one processor, cause the apparatus at least to perform: defining an activation message for processing, wherein one invocation of the processing results into multiple output pictures; and including, in the activation message, information indicating which set of the multiple output pictures is suggested to be processed further.

### TECHNICAL FIELD

The examples and non-limiting embodiments relate generally to frame rate coding, and more particularly, to method, apparatus, and computer program product for asymmetric frame rate coding of regions of interest.

### BACKGROUND

It is known to provide video encoding and decoding.

### SUMMARY

An example apparatus includes at least one processor; and at least one non-transitory memory storing instructions that, when executed by the at least one processor, cause the apparatus at least to perform: obtaining a one or more pictures; obtaining information on one or more regions of interest (ROIs) in the one or more pictures; arranging the one or more ROIs of a first set of timestamps into a first constituent frame sequence; arranging non-ROIs or content frames of a second set of timestamps in a second constituent frame sequence, wherein the second set of timestamps at least partially differs from the first set of timestamps, wherein the non-ROIs comprise regions other than the ROIs; and encoding the first constituent frame sequence and the second constituent frame sequence into or along a bitstream.

The example apparatus may further include, wherein at least one timestamp in the second set of timestamps is different from the timestamps in the first set of timestamps.

The example apparatus may further include, wherein the apparatus is further caused to define a constituent frame as one of the following: a rectangular region within a frame comprising one or more other constituent frames; a frame within two or more adjacent frames, in output order, that correspond to same display timestamp; or a first frame in an access unit that also comprises one or more other frames originating from the same source frame as the first frame, wherein the first frame and the one or more other frames reside in different scalability layers.

The example apparatus may further include, wherein the apparatus is further caused to perform defining a constituent frame sequence as a sequence of corresponding constituent frames within a frame sequence, wherein corresponding constituent frames comprise: spatially collocated frames; frames in the same position within the two or more adjacent frames, in output order, that correspond to same display timestamp; frames in different scalability layers in same access unit; or frames in different bitstreams, wherein the bitstreams are associated with each other.

The example apparatus may further include, wherein: a content frame correspond to a captured image; the content frame is considered to enclose an entire source frame; or the content frame is encoded as the constituent frame.

The example apparatus may further include, wherein when a frame comprises a first constituent frame comprising an ROI and a second constituent frame comprising a content frame, or the first constituent frame comprising an ROI, the apparatus is further caused to perform: encoding a scaling window for each frame in the bitstream, wherein the scaling window matches with the ROI boundaries within each frame; predicting a picture at a timestamp (t1) respective ROIs of a previous timestamp (t0) and a later timestamp (t2); predicting the ROI in t2 from the ROI in t0; and predicting a content frame in t2 from a content frame in to.

The example apparatus may further include, wherein when a frame comprises a first constituent frame comprising an ROI and a second constituent frame comprising a content frame, or a first constituent frame comprising an ROI, the apparatus is further caused to perform: encoding a scaling window for each frame in the bitstream, wherein the scaling window matches with the content frame boundaries within each frame, and wherein the scaling window covers low-resolution content frame in a timestamp (t0) and a timestamp (t2) and the content frame comprising the high-resolution ROI in a timestamp (t1); and predicting a picture in the t1 from respective low-resolution areas in t0 and t2.

The example apparatus may further include, wherein the apparatus is further caused to perform: indicating temporal interleaving of alternating first and second constituent frames; and defining or obtaining correspondence of first constituent frame comprises ROI in relation to second constituent frame.

The example apparatus may further include, wherein the apparatus is further caused to perform: selecting a first set of timestamps in the first constituent frame sequence; or selecting a second set of timestamps in the second constituent frame sequence.

The example apparatus may further include, wherein the apparatus is further caused to perform estimating or deriving a machine analysis precision of a composed video sequence resulting from fusing the first constituent frame sequence and the second constituent frame sequence, for different sets of timestamps selected to be included in the first constituent frame sequence and the second constituent frame sequence.

The example apparatus may further include, wherein the apparatus is further caused to perform inferring a source of an input picture coinciding with the interpolated picture generated by a post-processing filter according one or more of the following conditions: when the post-processing filter is activated for a dependent layer, the input picture coinciding with the interpolated pictures generated by the post-processing filter originate from a reference layer of a dependent layer comprising a highest layer identifier; when the post-processing filter is activated for a picture that comprises the first constituent frame in temporal interleaving frame packing arrangement, the input picture coinciding with the interpolated picture generated by the post-processing filter originate from pictures comprising the second constituent frame in temporal interleaving frame packing arrangement; when the post-processing filter is activated for a picture that comprises a second constituent frame in temporal interleaving frame packing arrangement, the input picture coinciding with the interpolated picture generated by the post-processing filter originate from pictures comprising the first constituent frame in temporal interleaving frame packing arrangement; or when spatial packing is in use, and a constituent frame outside of a scaling window is defined to be in the scope of the indication message, and a picture coinciding with the interpolated picture has no the constituent frame outside of the scaling window, the input picture is the constituent frame within the scaling window in the picture.

The example apparatus may further include, the apparatus is further caused to perform appending the indication message with an indication of the source of the input picture coinciding with the interpolated pictures generated by the post-processing filter, wherein the source comprises one or more of the following: information indicative of a scalability layer; a reference layer of the current scalability layer where the post-processing filter defined by the indication message is active, and wherein the reference layer is inferred to be a reference layer comprising highest layer identifier, or the layer identifier of the reference layer is indicated; when temporal interleaving is indicated, the source comprises an opposite constituent frame of the constituent frame pair that also comprises the constituent frame to which the post-processing filter defined by the indication message is active; or when spatial packing is in use, and a constituent frame outside of the scaling window are defined to be in the scope of the indication message, and a picture coinciding with the interpolated picture has no constituent frame outside of the scaling window, the source comprises the constituent frame within the scaling window in the picture.

The example apparatus may further include, wherein the apparatus is further caused to perform generating at least one of following enhancement indication messages: a first indication message that defines a frame rate upsampling filter, which takes two adjacent frames as input, generates one interpolated between adjacent frames, and also takes one frame coinciding with the interpolated frame as input; a second indication message that defines a spatial upsampling filter; in a picture unit comprising the constituent frame at timestamp t1 comprising a content frame: a regional nesting indication message, wherein a region encloses the ROI within the content frame and the region nesting indication message comprising a third indication message activating the spatial upsampling filter; or in a picture unit comprising the constituent frame at timestamp t2 containing ROI: the third indication message activating the frame rate upsampling filter.

Another example apparatus includes at least one processor; and at least one non-transitory memory storing instructions that, when executed by the at least one processor, cause the apparatus at least to perform: decoding a bitstream into a decoded frame sequence; identifying a first constituent frame sequence and a second constituent frame sequence from the decoded frame sequence, wherein the first constituent frame sequence corresponds to a first set of timestamps, the second constituent frame sequence corresponds to a second set of timestamps, the second set of timestamps at least partially differs from the first set of timestamps; and fusing the first constituent frame sequence and the second constituent frame sequence into a composed video sequence corresponding to a union of the first and second sets of timestamps.

The example apparatus may further include, wherein the apparatus is further caused to perform upsampling a frame rate for the first constituent frame sequence.

The example apparatus may further include, wherein the apparatus is further caused to perform: identifying one or more ROIs to be generated; and initializing a composed frame to be an upsampled content frame carried in the second constituent frame, and perform the following for each ROI to be generated: frame rate upsampling to create a generated ROI; and update the composed frame by overlaying the generated ROI on top of the composed frame.

The example apparatus may further include, wherein the apparatus is further caused to perform identifying a missing constituent frame comprising an ROI.

The example apparatus may further include, wherein to identify the missing constituent frame the apparatus is caused to perform: decoding or inferring that packing of constituent frames is applied in the bitstream; decoding or inferring which type of packing of constituent frames is applied in the bitstream; decoding or inferring which frames and/or regions comprise constituent frame comprising ROI and which frames and/or regions comprise non-ROI or background; decoding or inferring which constituent frames form constituent frame pairs of same timestamp; and identifying an unpaired constituent frame pair that comprises the constituent frame that includes non-ROI or background.

The example apparatus may further include, wherein the apparatus is caused to perform identifying one or more ROI within the missing constituent frame to be generated.

The example apparatus may further include, wherein to identify one or more ROI within the missing constituent frame to be generated, the apparatus is caused to perform: decoding an annotated regions indication message for a time-aligned content frame; generating first set of ROIs that are indicated by the annotated regions indication message; decoding annotated regions indication message for a content frame or a constituent frame comprising one or more ROIs that are time-wise adjacent to the missing constituent frame; generating a second set of ROIs that are indicated by the annotated regions indication message; detecting a third set of ROIs from the time-aligned content frame; generating the detected third set of ROIs; detecting a fourth set of ROIs from the content frame or constituent frame comprising at least on ROI that time-wise adjacent to the missing constituent frame; and generating the detected fourth set of ROIs.

The example apparatus may further include, wherein the apparatus is caused to perform: receiving the time-aligned content frame and the time adjacent and time-wise adjacent constituent frames comprising one or more ROIs; and creating a constituent frame comprising the one or more ROIs corresponding to the time-aligned content frame.

The example apparatus may further include, wherein the apparatus is caused to perform: receiving an ROI bounding box region from the time-aligned content frame and the time-wise adjacent constituent frames comprising one or more ROIs; and creating an ROI corresponding to the time-aligned content frame.

The example apparatus may further include, wherein the apparatus is further caused to perform upsampling the ROI bounding box region to comprise the same width and height as in the constituent frames.

The example apparatus may further include, wherein the apparatus is further caused to perform: for timestamps t₀ and t₂ overlaying the constituent frame comprising the ROI on top of an upsampled content frame; for timestamp t₁, overlaying an ROI generated by a neural network post-filter on top of the upsampled content frame; and providing overlaid upsampled content frame as an input to a task neural network.

The example apparatus may further include, wherein for each timestamp when the second constituent frame does not have the corresponding first constituent frame, the apparatus is further caused to perform: identifying one or more ROIs to be generated; initializing a composed frame to be an upsampled content frame carried in the second constituent frame; and performing frame rate upsampling for each ROI to be generated to update the composed frame.

Yet another example apparatus includes at least one processor; and at least one non-transitory memory storing instructions that, when executed by the at least one processor, cause the apparatus at least to perform: receiving following as input: a first constituent frame; a second constituent frame that is time-aligned with the first constituent frame; and information indicative of one or more regions of the first constituent frame to be filtered with guidance or supervision from the second constituent frame; and enhancing the indicated regions of the first constituent frame based on the respective regions of the second constituent frame.

Still another example apparatus includes at least one processor; and at least one non-transitory memory storing instructions that, when executed by the at least one processor, cause the apparatus at least to perform: receiving following as input: a first constituent frame; a second constituent frame that is time-aligned with the first constituent frame; and information indicative of one or regions of the first constituent frame to be filtered with guidance or supervision from the second constituent frame; and defining in or along a bitstream an NN post-filter for enhancing indicated regions of the first constituent frame based on respective regions of the second constituent frame.

The example apparatus may further include, wherein the apparatus is further caused to perform indicating in or along the bitstream which pairs of the first and second constituent frames the NN post-filter is to be used for or is to be activated.

The example apparatus may further include, wherein the apparatus is further caused to perform defining an indication message to include a flag for indicating a filtering purpose.

An example method includes: obtaining a one or more pictures; obtaining information on one or more regions of interest (ROIs) in the one or more pictures; arranging the one or more ROIs of a first set of timestamps into a first constituent frame sequence; arranging non-ROIs or content frames of a second set of timestamps in a second constituent frame sequence, wherein the second set of timestamps at least partially differs from the first set of timestamps, wherein the non-ROIs comprise regions other than the ROIs; and encoding the first constituent frame sequence and the second constituent frame sequence into or along a bitstream.

The example method may further include, wherein at least one timestamp in the second set of timestamps is different from the timestamps in the first set of timestamps.

The example method may further include defining a constituent frame as one of the following: a rectangular region within a frame comprising one or more other constituent frames; a frame within two or more adjacent frames, in output order, that correspond to same display timestamp; or a first frame in an access unit that also comprises one or more other frames originating from the same source frame as the first frame, wherein the first frame and the one or more other frames reside in different scalability layers.

The example method may further include defining a constituent frame sequence as a sequence of corresponding constituent frames within a frame sequence, wherein corresponding constituent frames comprise: spatially collocated frames; frames in the same position within the two or more adjacent frames, in output order, that correspond to same display timestamp; frames in different scalability layers in same access unit; or frames in different bitstreams, wherein the bitstreams are associated with each other.

The example method may further include, wherein: a content frame correspond to a captured image; the content frame is considered to enclose an entire source frame; or the content frame is encoded as the constituent frame.

The example method may further include, wherein when a frame comprises a first constituent frame comprising an ROI and a second constituent frame comprising a content frame, or the first constituent frame comprising an ROI the method further comprises: encoding a scaling window for each frame in the bitstream, wherein the scaling window matches with the ROI boundaries within each frame; predicting a picture at a timestamp (t1) respective ROIs of a previous timestamp (t0) and a later timestamp (t2); predicting the ROI in t2 from the ROI in t0; and predicting a content frame in t2 from a content frame in t0.

The example method may further include, wherein when a frame comprises a first constituent frame comprising an ROI and a second constituent frame comprising a content frame, or a first constituent frame comprising an ROI the method further comprises: encoding a scaling window for each frame in the bitstream, wherein the scaling window matches with the content frame boundaries within each frame, and wherein the scaling window covers low-resolution content frame in a timestamp (t0) and a timestamp (t2) and the content frame comprising the high-resolution ROI in a timestamp (t1); predicting a picture in the t1 from respective low-resolution areas in t0 and t2.

The example method may further include: indicating temporal interleaving of alternating first and second constituent frames; and defining or obtaining correspondence of first constituent frame comprises ROI in relation to second constituent frame.

The example method may further include: selecting a first set of timestamps in the first constituent frame sequence; or selecting a second set of timestamps in the second constituent frame sequence.

The example method may further include estimating or deriving a machine analysis precision of a composed video sequence resulting from fusing the first constituent frame sequence and the second constituent frame sequence, for different sets of timestamps selected to be included in the first constituent frame sequence and the second constituent frame sequence.

The example method may further include inferring a source of an input picture coinciding with the interpolated picture generated by a post-processing filter according one or more of the following conditions: when the post-processing filter is activated for a dependent layer, the input picture coinciding with the interpolated pictures generated by the post-processing filter originate from a reference layer of a dependent layer comprising a highest layer identifier; when the post-processing filter is activated for a picture that comprises the first constituent frame in temporal interleaving frame packing arrangement, the input picture coinciding with the interpolated picture generated by the post-processing filter originate from pictures comprising the second constituent frame in temporal interleaving frame packing arrangement; when the post-processing filter is activated for a picture that comprises a second constituent frame in temporal interleaving frame packing arrangement, the input picture coinciding with the interpolated picture generated by the post-processing filter originate from pictures comprising the first constituent frame in temporal interleaving frame packing arrangement; or when spatial packing is in use, and a constituent frame outside of a scaling window is defined to be in the scope of the indication message, and a picture coinciding with the interpolated picture has no the constituent frame outside of the scaling window, the input picture is the constituent frame within the scaling window in the picture.

The example method may further include appending the indication message with an indication of the source of the input picture coinciding with the interpolated pictures generated by the post-processing filter, wherein the source comprises one or more of the following: information indicative of a scalability layer; a reference layer of the current scalability layer where the post-processing filter defined by the indication message is active, and wherein the reference layer is inferred to be a reference layer comprising highest layer identifier, or the layer identifier of the reference layer is indicated; when temporal interleaving is indicated, the source comprises an opposite constituent frame of the constituent frame pair that also comprises the constituent frame to which the post-processing filter defined by the indication message is active; or when spatial packing is in use, and a constituent frame outside of the scaling window are defined to be in the scope of the indication message, and a picture coinciding with the interpolated picture has no constituent frame outside of the scaling window, the source comprises the constituent frame within the scaling window in the picture.

The example method may further include generating at least one of following enhancement indication messages: a first indication message that defines a frame rate upsampling filter, which takes two adjacent frames as input, generates one interpolated between adjacent frames, and also takes one frame coinciding with the interpolated frame as input; a second indication message that defines a spatial upsampling filter; in a picture unit comprising the constituent frame at timestamp t1 comprising a content frame: a regional nesting indication message, wherein a region encloses the ROI within the content frame and the region nesting indication message comprising a third indication message activating the spatial upsampling filter; or in a picture unit comprising the constituent frame at timestamp t2 containing ROI: the third indication message activating the frame rate upsampling filter.

Another example method includes: decoding a bitstream into a decoded frame sequence; identifying a first constituent frame sequence and a second constituent frame sequence from the decoded frame sequence, wherein the first constituent frame sequence corresponds to a first set of timestamps, the second constituent frame sequence corresponds to a second set of timestamps, the second set of timestamps at least partially differs from the first set of timestamps; and fusing the first constituent frame sequence and the second constituent frame sequence into a composed video sequence corresponding to a union of the first and second sets of timestamps.

The example method may further include upsampling a frame rate for the first constituent frame sequence.

The example method may further include: identifying one or more ROIs to be generated; and initializing a composed frame to be an upsampled content frame carried in the second constituent frame, and perform the following for each ROI to be generated: frame rate upsampling to create a generated ROI; and update the composed frame by overlaying the generated ROI on top of the composed frame.

The example method may further include identifying a missing constituent frame comprising an ROI.

The example method may further include, wherein identifying the missing constituent frame comprises: decoding or infer that packing of constituent frames is applied in the bitstream; decoding or infer which type of packing of constituent frames is applied in the bitstream; decoding or infer which frames and/or regions comprise constituent frame comprising ROI and which frames and/or regions comprise non-ROI or background; decoding or inferring which constituent frames form constituent frame pairs of same timestamp; and identifying an unpaired constituent frame pair that comprises the constituent frame that includes non-ROI or background.

The example method may further include identifying one or more ROI within the missing constituent frame to be generated.

The example method may further include, wherein identifying one or more ROI within the missing constituent frame to be generated comprises: decoding an annotated regions indication message for a time-aligned content frame; generate first set of ROIs that are indicated by the annotated regions indication message; decoding annotated regions indication message for a content frame or a constituent frame comprising one or more ROIs that are time-wise adjacent to the missing constituent frame; generating a second set of ROIs that are indicated by the annotated regions indication message; detecting a third set of ROIs from the time-aligned content frame; generating the detected third set of ROIs; detecting a fourth set of ROIs from the content frame or constituent frame comprising at least on ROI that time-wise adjacent to the missing constituent frame; and generating the detected fourth set of ROIs.

The example method may further include: receiving the time-aligned content frame and the time adjacent and time-wise adjacent constituent frames comprising one or more ROIs; and creating a constituent frame comprising the one or more ROIs corresponding to the time-aligned content frame.

The example method may further include: receiving an ROI bounding box region from the time-aligned content frame and the time-wise adjacent constituent frames comprising one or more ROIs; and creating an ROI corresponding to the time-aligned content frame.

The example method may further include upsampling the ROI bounding box region to comprise the same width and height as in the constituent frames.

The example method may further include: for timestamps t₀ and t₂ overlaying the constituent frame comprising the ROI on top of an upsampled content frame; for timestamp t₁, overlaying an ROI generated by a neural network post-filter on top of the upsampled content frame; and providing overlaid upsampled content frame as an input to a task neural network.

The example method may further include, wherein for each timestamp when the second constituent frame does not have the corresponding first constituent frame, the method is further comprises: identifying one or more ROIs to be generated; initializing a composed frame to be an upsampled content frame carried in the second constituent frame; and performing frame rate upsampling for each ROI to be generated to update the composed frame.

Yet another example method includes: receiving following as input: a first constituent frame; a second constituent frame that is time-aligned with the first constituent frame; and information indicative of one or more regions of the first constituent frame to be filtered with guidance or supervision from the second constituent frame; and enhancing the indicated regions of the first constituent frame based on the respective regions of the second constituent frame.

Still another example method includes: receiving following as input: a first constituent frame; a second constituent frame that is time-aligned with the first constituent frame; and information indicative of one or regions of the first constituent frame to be filtered with guidance or supervision from the second constituent frame; and defining in or along a bitstream an NN post-filter for enhancing indicated regions of the first constituent frame based on respective regions of the second constituent frame.

The example method may further include indicating in or along the bitstream which pairs of the first and second constituent frames the NN post-filter is to be used for or is to be activated.

The example method may further include defining an indication message to include a flag for indicating a filtering purpose.

Still another example apparatus includes at least one processor; and at least one non-transitory memory storing instructions that, when executed by the at least one processor, cause the apparatus at least to perform: defining an activation message for processing, wherein one invocation of the processing results into multiple output pictures; and including, in the activation message, information indicating which set of the multiple output pictures is suggested to be processed further.

The example apparatus may further include, wherein the apparatus is further caused to perform: signaling the activation message to a decoder.

The example apparatus may further include, wherein the processing comprises a filtering process of one or more reconstructed pictures.

The example apparatus may further include, wherein the activation message comprises a neural network post filter activation (NNPFA) supplemental enhancement information (SEI) message.

Still another example apparatus includes at least one processor; and at least one non-transitory memory storing instructions that, when executed by the at least one processor, cause the apparatus at least to perform: receiving an activation message for processing, wherein one invocation of the processing results into multiple output pictures and the activation message comprises information indicating which set of the multiple output pictures is suggested to be processed further; invoking the processing according to the activation message; and further processing the set of the multiple output pictures based on the information.

The example apparatus may further include, wherein the processing comprises a filtering process of one or more reconstructed pictures.

The example apparatus may further include, wherein the activation message comprises a neural network post filter activation (NNPFA) supplemental enhancement information (SEI) message.

Still another example method includes: defining an activation message for processing, wherein one invocation of the processing results into multiple output pictures; and including, in the activation message, information indicating which set of the multiple output pictures is suggested to be processed further.

The example method may further include signaling the activation message to a decoder.

The example method may further include, wherein the processing comprises a filtering process of one or more reconstructed pictures.

The example method may further include, wherein the activation message comprises a neural network post filter activation (NNPFA) supplemental enhancement information (SEI) message.

Still another example method includes: receiving an activation message for processing, wherein one invocation of the processing results into multiple output pictures and the activation message comprises information indicating which set of the multiple output pictures is suggested to be processed further; invoking the processing according to the activation message; and further processing the set of the multiple output pictures based on the information.

The example method may further include, wherein the processing comprises a filtering process of one or more reconstructed pictures.

The example method may further include, wherein the activation message comprises a neural network post filter activation (NNPFA) supplemental enhancement information (SEI) message.

An example non-transitory computer readable medium includes program instructions that, when executed by an apparatus, cause the apparatus to perform to perform the methods as described in any of the previous paragraphs.

Still another example apparatus includes means for performing methods as described in any of the previous paragraphs.

### BRIEF DESCRIPTION OF THE DRAWINGS

The foregoing embodiments and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 4 illustrates an example of encoding, in accordance with an embodiment.

FIG. 5 illustrates an example decoding, in accordance with an embodiment.

FIG. 6 illustrates various examples of packing a first constituent frame sequence comprising ROIs and a second constituent frame sequence representing content frames.

FIG. 7 illustrates an example usage of scaling windows for indicating spatial correspondence for inter prediction in spatial packing, in accordance with an embodiment.

FIG. 8 illustrates an example usage of scaling windows for indicating spatial correspondence for inter prediction in spatial packing, in accordance with another embodiment.

FIG. 9. illustrates an example usage of scaling windows for indicating spatial correspondence for inter prediction in temporal interleaving, in accordance with an embodiment.

FIG. 10 illustrates an upsampling frame rate of ROI constituent frames assisted by a time-aligned content frame, in accordance with an embodiment.

FIG. 11 illustrates an upsampling frame rate of ROI constituent frames assisted by an ROI extracted from a time-aligned content frame, in accordance with an embodiment.

FIG. 12 illustrates an example of ROI overlaying and usage of ROI-overlaid upsampled content frames as input to task NN, in accordance with an embodiment.

FIG. 13 illustrates upsampling frame rate of ROI-overlaid frames assisted by a time-aligned content frame, in accordance with an embodiment.

FIG. 14 is an example apparatus, which may be implemented in hardware, and is caused to, perform asymmetric frame rate coding of regions of interest based on the examples described herein.

FIG. 15 is an example method to implement the embodiments described herein, in accordance with an embodiment.

FIG. 16 is an example method to implement the embodiments described herein, in accordance with another embodiment.

FIG. 17 is an example method to implement the embodiments described herein, in accordance with yet another embodiment.

FIG. 18 is an example method to implement the embodiments described herein, in accordance with still another embodiment.

FIG. 19 is an example method to implement the embodiments described herein, in accordance with still another embodiment.

FIG. 20 is an example method to implement the embodiments described herein, in accordance with still another embodiment.

FIG. 21 is a block diagram of one possible and non-limiting system in which the example embodiments may be practiced.

### DETAILED DESCRIPTION OF EXAMPLE EMBODIMENTS

The following acronyms and abbreviations that may be found in the specification and/or the drawing figures are defined as follows:
3GP 3GPP file format
3GPP 3rd Generation Partnership Project
3GPP TS 3GPP technical specification
4CC four character code
4G fourth generation of broadband cellular network technology
5G fifth generation cellular network technology
5GC 5G core network
ACC accuracy
AGT approximated ground truth data
AI artificial intelligence
AIoT AI-enabled IoT
ALF adaptive loop filtering
a.k.a. also known as
AMF access and mobility management function
APS adaptation parameter set
AVC advanced video coding
bpp bits-per-pixel
CABAC context-adaptive binary arithmetic coding
CDMA code-division multiple access
CE core experiment
ctu coding tree unit
CU central unit
CVC conventional video codec
DASH dynamic adaptive streaming over HTTP
DCT discrete cosine transform
DCI decoding compatibility information
DSP digital signal processor
DSNN decoder-side NN
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
FDMA frequency division multiple access
f(n) fixed-pattern bit string using n bits written (from left to right) with the left bit first.
F1 or F1-C interface between CU and DU control interface
FDC finetuning-driving content
gNB (or gNodeB) base station for 5G/NR, for example, a node providing NR user plane and control plane protocol terminations towards the
UE, and connected via the NG interface to the 5GC
GSM Global System for Mobile communications
GT ground truth
H.222.0 MPEG-2 Systems is formally known as ISO/IEC 13818-1 and as ITU-T Rec. H.222.0
H.26x family of video coding standards in the domain of the ITU-T
HLS high level syntax
HQ high-quality
IBC intra block copy
ID identifier
IEC International Electrotechnical Commission
IEEE Institute of Electrical and Electronics Engineers
I/F interface
IMD integrated messaging device
IMS instant messaging service
IoT internet of things
IP internet protocol
IRAP intra random access point
ISO International Organization for Standardization
ISOBMFF ISO base media file format
ITU International Telecommunication Union
ITU-T ITU Telecommunication Standardization Sector
JPEG joint photographic experts group
LCVC lossy conventional video codec
LIC learned image compression
LL-CVC lossless conventional video codec
LMCS luma mapping with chroma scaling
LPNN loss proxy NN
LQ low-quality
LTE long-term evolution
LZMA Lempel-Ziv-Markov chain compression
LZMA2 simple container format that can include both uncompressed data and LZMA data
LZO Lempel-Ziv-Oberhumer compression
LZW Lempel-Ziv-Welch compression
MAC medium access control
mdat MediaDataBox
MME mobility management entity
MMS multimedia messaging service
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
MSB most significant bit
MSE Mean-squared error
NAL network abstraction layer
NDU NN compressed data unit
ng or NG new generation
ng-eNB or NG-eNB new generation eNB
NN neural network
NNEF neural network exchange format
NNR neural network representation
NR new radio (5G radio)
N/W or NW network
OBU open bitstream unit
ONNX Open Neural Network eXchange
PB protocol buffers
PC personal computer
PDA personal digital assistant
PDCP packet data convergence protocol
PHY physical layer
PID packet identifier
PLC power line communication
PNG portable network graphics
PPS picture parameter set
PSNR peak signal-to-noise ratio
RA Random access
RAM random access memory
RAN radio access network
RBSP raw byte sequence payload
RD loss rate distortion loss
RFC request for comments
RFID radio frequency identification
RLC radio link control
RPR reference picture resampling
RRC radio resource control
RRH remote radio head
RU radio unit
Rx receiver
SDAP service data adaptation protocol
SGD Stochastic Gradient Descent
SGW serving gateway
SMF session management function
SMS short messaging service
SPS sequence parameter set
st (v) null-terminated string encoded as UTF-8 characters as specified in ISO/IEC 10646
SVC scalable video coding
S1 interface between eNodeBs and the EPC
TCP-IP transmission control protocol-internet protocol
TDMA time divisional multiple access
TID temporal identifier
trak TrackBox
TS transport stream
TUC technology under consideration
TV television
Tx transmitter
UE user equipment
ue (v) unsigned integer Exp-Golomb-coded syntax element with the left bit first
UICC Universal Integrated Circuit Card
UMTS Universal Mobile Telecommunications System
u(n) unsigned integer using n bits
UPF user plane function
URI uniform resource identifier
URL uniform resource locator
UTF-8 8-bit Unicode Transformation Format
VPS video parameter set
WLAN wireless local area network
X2 interconnecting interface between two eNodeBs in LTE network
Xn interface between two NG-RAN nodes

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a ‘computer-readable storage medium,’ which refers to a non-transitory physical storage medium (e.g., volatile or non-volatile memory device), can be differentiated from a ‘computer-readable transmission medium,’ which refers to an electromagnetic signal.

A method, apparatus and computer program product are provided in accordance with example embodiments for asymmetric frame rate coding of regions of interest. In an embodiment, the regions of interest are coded for machine consumption.

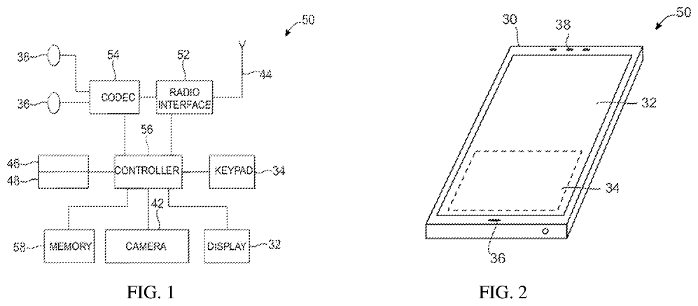

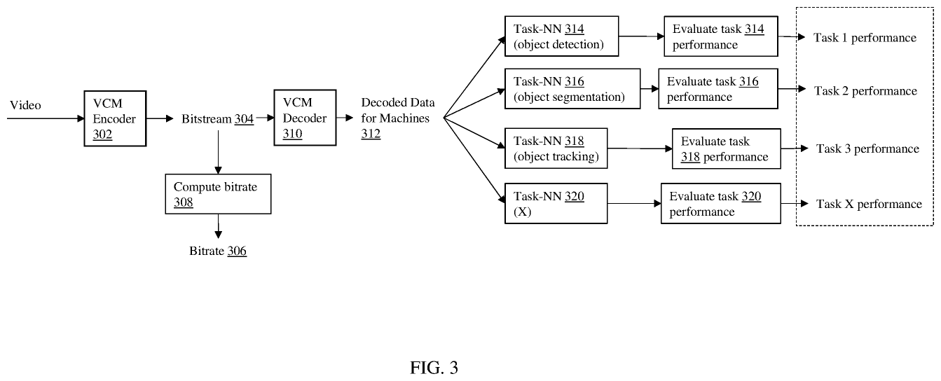

In an example, the following describes in detail suitable apparatus and possible mechanisms for implementing transformer based video coding. In this regard reference is first made to FIG. 1 and FIG. 2, where FIG. 1 shows an example block diagram of an apparatus 50. The apparatus may be an Internet of Things (IoT) apparatus configured to perform various functions, for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 will be explained next.

The apparatus 50 may for example be a mobile terminal or user equipment of a wireless communication system, a sensor device, a tag, or a lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 may further comprise a display 32, for example, in the form of a liquid crystal display, light emitting diode display, organic light emitting diode display, and the like. In other embodiments of the examples described herein the display may be any suitable display technology suitable to display media or multimedia content, for example, an image or a video. The apparatus 50 may further comprise a keypad 34. In other embodiments of the examples described herein any suitable data or user interface mechanism may be employed. For example, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the examples described herein may be any one of: an earpiece 38, speaker, or an analogue audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, a processor or a processor circuitry for controlling the apparatus 50. The controller 56 may be connected to a memory 58 which in embodiments of the examples described herein may store both data in the form of an image, audio data and video data, and/or may also store instructions for implementation on the controller 56. The controller 56 may further be connected to codec circuitry 54 suitable for carrying out coding and/or decoding of audio, image and/or video data or assisting in coding and/or decoding carried out by the controller.

The apparatus 50 may further comprise a card reader 48 and a smart card 46, for example, a UICC and UICC reader for providing user information and being suitable for providing authentication information for authentication and authorization of the user at a network.

The apparatus 50 may comprise radio interface circuitry 52 connected to the controller and suitable for generating wireless communication signals, for example, for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera 42 capable of recording or detecting individual frames which are then passed to the codec circuitry 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

### Fundamentals of Neural Networks

A neural network (NN) is a computation graph consisting of several layers of computation. Each layer consists of one or more units, where each unit performs a computation. A unit is connected to one or more other units, and a connection may be associated with a weight. The weight may be used for scaling the signal passing through an associated connection. Weights are learnable parameters, for example, values which can be learned from training data. There may be other learnable parameters, such as those of batch-normalization layers.

Couple of examples of architectures for neural networks are feed-forward and recurrent architectures. Feed-forward neural networks are such that there is no feedback loop, each layer takes input from one or more of the previous layers, and provides its output as the input for one or more of the subsequent layers. Also, units inside a certain layer take input from units in one or more of preceding layers and provide output to one or more of following layers.

Initial layers, those close to the input data, extract semantically low-level features, for example, edges and textures in images, and intermediate and final layers extract more high-level features. After the feature extraction layers there may be one or more layers performing a certain task, for example, classification, semantic segmentation, object detection, denoising, style transfer, super-resolution, and the like. In recurrent neural networks, there is a feedback loop, so that the neural network becomes stateful, for example, it is able to memorize information or a state.

Neural networks are being utilized in an ever-increasing number of applications for many different types of devices, for example, mobile phones, chat bots, IoT devices, smart cars, voice assistants, and the like. Some of these applications include, but are not limited to, image and video analysis and processing, social media data analysis, device usage data analysis, and the like.

One of the properties of neural networks, and other machine learning tools, is that they are able to learn properties from input data, either in a supervised way or in an unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output error, also referred to as the loss. Examples of losses are mean squared error, cross-entropy, and the like. In recent deep learning techniques, training is an iterative process, where at each iteration the algorithm modifies the weights of the neural network to make a gradual improvement in the network's output, for example, gradually decrease the loss.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, for example, data which was not used for training the model. This is usually referred to as generalization. In practice, data is usually split into at least two sets, the training set and the validation set. The training set is used for training the network, for example, to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following:
when the network is learning at all—in this case, the training set error should decrease, otherwise the model is in the regime of underfitting.
when the network is learning to generalize—in this case, also the validation set error needs to decrease and be not too much higher than the training set error. For example, the validation set error should be less than 20% higher than the training set error. If the training set error is low, for example 10% of its value at the beginning of training, or with respect to a threshold that may have been determined based on an evaluation metric, but the validation set error is much higher than the training set error, or it does not decrease, or it even increases, the model is in the regime of overfitting. This means that the model has just memorized properties of the training set and performs well only on that set, but performs poorly on a set not used for training or tuning of its parameters.

Lately, neural networks have been used for compressing and de-compressing data such as images. The most widely used architecture for such task is the auto-encoder, which is a neural network consisting of two parts: a neural encoder and a neural decoder. In various embodiments, these neural encoder and neural decoder would be referred to as encoder and decoder, even though these refer to algorithms which are learned from data instead of being tuned manually. The encoder takes an image as an input and produces a code, to represent the input image, which requires less bits than the input image. This code may have been obtained by a binarization or quantization process after the encoder. The decoder takes in this code and reconstructs the image which was input to the encoder.

Such encoder and decoder are usually trained to minimize a combination of bitrate and distortion, where the distortion may be based on one or more of the following metrics: mean squared error (MSE), peak signal-to-noise ratio (PSNR), structural similarity index measure (SSIM), or the like. These distortion metrics are meant to be correlated to the human visual perception quality, so that minimizing or maximizing one or more of these distortion metrics results into improving the visual quality of the decoded image as perceived by humans.

In various embodiments, terms ‘model’, ‘neural network’, ‘neural net’ and ‘network’ may be used interchangeably, and also the weights of neural networks may be sometimes referred to as learnable parameters or as parameters.

### Some Video Coding and Video Metadata Specifications

The Advanced Video Coding standard (which may be abbreviated H.264, AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated H.265, HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance for Open Media (AOM). The AV1 specification was published in 2018. AOM is reportedly working on the AV2 specification.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams. VUI parameters and SEI messages may, for example, assist in processes related to decoding, display or other purposes.

### Fundamentals of Video/Image Coding

Video codec consists of an encoder that transforms the input video into a compressed representation suited for storage/transmission and a decoder that can decompress the compressed video representation back into a viewable form. Typically, an encoder discards some information in the original video sequence in order to represent the video in a more compact form, for example, at lower bitrate.

Typical hybrid video codecs, for example ITU-T H.263 and H.264, encode the video information in two phases. Firstly, pixel values in a certain picture area (or ‘block’) are predicted, for example, by motion compensation means or circuits (by finding and indicating an area in one of the previously coded video frames that corresponds closely to the block being coded) or by spatial means or circuit (by using the pixel values around the block to be coded in a specified manner). Secondly the prediction error, e.g. the difference between the predicted block of pixels and the original block of pixels, is coded. This is typically done by transforming the difference in pixel values using a specified transform (e.g. discrete cosine transform (DCT) or a variant of it), quantizing the coefficients and entropy coding the quantized coefficients. By varying the fidelity of the quantization process, the encoder may control the balance between the accuracy of the pixel representation (e.g., picture quality) and size of the resulting coded video representation (e.g., file size or transmission bitrate).

In other example, the pixel values may be predicted by using spatial prediction techniques. This prediction technique uses the pixel values around the block to be coded in a specified manner. Secondly, the prediction error, for example, the difference between the predicted block of pixels and the original block of pixels is coded. This is typically done by transforming the difference in pixel values using a specified transform, for example, discrete cosine transform (DCT) or a variant of it; quantizing the coefficients; and entropy coding the quantized coefficients. By varying the fidelity of the quantization process, encoder can control the balance between the accuracy of the pixel representation, for example, picture quality and size of the resulting coded video representation, for example, file size or transmission bitrate.

Inter prediction, which may also be referred to as temporal prediction, motion compensation, or motion-compensated prediction, exploits temporal redundancy. In inter prediction the sources of prediction are previously decoded pictures, e.g., reference pictures.

In temporal inter prediction, the sources of prediction are previously decoded pictures in the same scalable layer. In intra block copy (IBC), e.g., intra-block-copy prediction, prediction may be applied similarly to temporal inter prediction but the reference picture is the current picture and only previously decoded samples may be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction provided that they are performed with the same or similar process than temporal prediction. Inter prediction, temporal inter prediction, or temporal prediction may sometimes be referred to as motion compensation or motion-compensated prediction.

Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra-coding, where no inter prediction is applied.

One example outcome of the coding procedure is a set of coding parameters, such as motion vectors and quantized transform coefficients. Many parameters can be entropy-coded more efficiently when they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction techniques similar to the encoder to form a predicted representation of the pixel blocks. For example, using the motion or spatial information created by the encoder and stored in the compressed representation and prediction error decoding, which is inverse operation of the prediction error coding recovering the quantized prediction error signal in spatial pixel domain. After applying prediction and prediction error decoding techniques the decoder sums up the prediction and prediction error signals, for example, pixel values to form the output video frame. The decoder and encoder can also apply additional filtering techniques to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded in the encoder side or decoded in the decoder side and the prediction source block in one of the previously coded or decoded pictures.

In order to represent motion vectors efficiently, the motion vectors are typically coded differentially with respect to block specific predicted motion vectors. In typical video codecs, the predicted motion vectors are created in a predefined way, for example, calculating the median of the encoded or decoded motion vectors of the adjacent blocks.

Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture.

Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs, the prediction residual after motion compensation is first transformed with a transform kernel, for example, DCT and then coded. The reason for this is that often there still exists some correlation among the residual and transform can in many cases help reduce this correlation and provide more efficient coding.

Typical video encoders utilize Lagrangian cost functions to find optimal coding modes, for example, the desired macroblock mode and associated motion vectors. This kind of cost function uses a weighting factor 2 to tie together the exact or estimated image distortion due to lossy coding methods and the exact or estimated amount of information that is required to represent the pixel values in an image area:

$$C = D + λ R \qquad equation 1$$

In equation 1, C is the Lagrangian cost to be minimized, D is the image distortion, for example, mean squared error with the mode and motion vectors considered, and R is the number of bits needed to represent the required data to reconstruct the image block in the decoder including the amount of data to represent the candidate motion vectors.

An out-of-band transmission, signaling, or storage may refer to the capability of transmitting, signaling, or storing information in a manner that associates the information with a video bitstream. The out-of-band transmission may use a more reliable transmission mechanism compared to the protocols used for carrying coded video data, such as slices. The out-of-band transmission, signaling or storage may additionally or alternatively be used, e.g., for ease of access or session negotiation. For example, a sample entry of a track in a file conforming to the ISO Base Media File Format may comprise parameter sets, while the coded data in the bitstream is stored elsewhere in the file or in another file. Another example of out-of-band transmission, signaling, or storage comprises including information, such as NN and/or NN updates in a file format track that is separate from track(s) including coded video data.

The phrase along the bitstream (e.g., indicating along the bitstream) or along a coded unit of a bitstream (e.g., indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is included in a container file, such as a file conforming to the ISO Base Media File Format, and certain file metadata is stored in the file in a manner that associates the metadata to the bitstream, such as boxes in the sample entry for a track including the bitstream, a sample group for the track including the bitstream, or a timed metadata track associated with the track including the bitstream. In another example, the phrase along the bitstream may be used when the bitstream is made available as a stream over a communication protocol and a media description, such as a streaming manifest, is provided to describe the stream.

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of a video encoder and the input of a video decoder, respectively, may be a network abstraction layer (NAL) unit. For transport over packet-oriented networks or storage into structured files, NAL units may be encapsulated into packets or similar structures. A bytestream format encapsulating NAL units may be used for transmission or storage environments that do not provide framing structures. The bytestream format may separate NAL units from each other by attaching a start code in front of each NAL unit. To avoid false detection of NAL unit boundaries, encoders may run a byte-oriented start code emulation prevention algorithm, which may add an emulation prevention byte to the NAL unit payload, when a start code would have occurred otherwise. In order to enable straightforward gateway operation between packet and stream-oriented systems, start code emulation prevention may be performed regardless of whether the bytestream format is in use or not. A NAL unit may be defined as a syntax structure including an indication of the type of data to follow and bytes including that data in the form of a raw byte sequence payload interspersed as necessary with emulation prevention bytes. A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some formats or standards, a first bitstream may be followed by a second bitstream in the same logical channel, such as in the same file or in the same connection of a communication protocol. An elementary stream (in the context of video coding) may be defined as a sequence of one or more bitstreams.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. The NAL unit header indicates the type of the NAL unit. In some coding standards, the NAL unit header indicates a scalability layer identifier (e.g., called nuh_layer_id in H.265/HEVC and H.266/VVC), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences may be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated, e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as TID, temporal layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

NAL units may be categorized into Video Coding Layer (VCL) NAL units and non-VCL NAL units. VCL NAL units are typically coded slice NAL units.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Video coding specifications may enable the use of supplemental enhancement information (SEI) messages or alike. Some video coding specifications include SEI NAL units, and some video coding specifications include both prefix SEI NAL units and suffix SEI NAL units, where the former type may start a picture unit or alike and the latter type may end a picture unit or alike. An SEI NAL unit may include one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient may not be defined. Consequently, encoders may be required to follow the standard specifying a SEI message when they create SEI message(s), and decoders may not be required to process SEI messages for output order conformance. One of the example reasons to include the syntax and semantics of SEI messages in standards is to allow different system specifications to interpret the supplemental information identically and hence interoperate. It is intended that system specifications may require the use of particular SEI messages both in the encoding end and in the decoding end, and additionally the process for handling particular SEI messages in the recipient may be specified.

Some video coding specifications enable metadata OBUs. A metadata OBU comprises a type field, which specifies the type of metadata.

A coded video sequence (CVS) may be defined as a sequence of coded pictures in decoding order that is independently decodable and is followed by another coded video sequence or the end of the bitstream.

A coded layer video sequence (CLVS) may be defined as a sequence of pictures and associated other data within the same scalable layer (e.g., with the same value of nuh_layer_id in VVC) that is decodable independently of other pictures in the same layer.

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance. The variable including a POC value of a picture may be referred to as PicOrderCntVal.

An identifier may be defined as a syntax element that identifies a syntax structure. A value of the identifier may for example differ in different instances of the same syntax structure, such as a parameter set. A particular instance of the syntax structure may be referenced through its identifier value. For example, a parameter set that is referenced by the (de) coding of a coded video slice may be identified by providing the identifier value of the parameter set in a header of the coded video slice.

An indicator (idc) may be defined as a syntax element whose value indicates a selection among more than two values (for which semantics have been specified). An indicator syntax element may have_idc postfix in its name.

Images may be split into independently codable and decodable image segments (e.g., slices or tiles or tile groups). Such image segments may enable parallel processing. Image segments may be coded as separate units in the bitstream, such as VCL NAL units in H.264/AVC, HEVC, and VVC. Coded image segments may comprise a header and a payload, wherein the header includes parameter values needed for decoding the payload.

In some video coding formats, such as HEVC and VVC, a picture is divided into one or more tile rows and one or more tile columns. A tile is a sequence of coding tree units (CTU) that covers a rectangular region of a picture. The partitioning to tiles forms a grid that may be characterized by a list of tile column widths (in CTUs) and a list of tile row heights (in CTUs). For encoding and/or decoding, the CTUs in a tile are scanned in raster scan order within that tile. In HEVC, tiles are ordered in the bitstream consecutively in the raster scan order of the tile grid.

In some video coding formats, such as AV1, a picture may be partitioned into tiles, and a tile consists of an integer number of complete superblocks that collectively form a complete rectangular region of a picture. In-picture prediction across tile boundaries may be disabled. The minimum tile size may be one superblock, and the maximum tile size in the presently specified levels in AV1 is 4096×2304 in terms of luma sample count. The picture is partitioned into a tile grid of one or more tile rows and one or more tile columns. The tile grid may be signaled in the picture header to have a uniform tile size or nonuniform tile size, where in the latter case the tile row heights and tile column widths are signaled. The superblocks in a tile are scanned in raster scan order within that tile.

In some video coding formats, such as VVC, a slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which includes an integer number of consecutive complete CTU rows within the tile.

In some video coding formats, such as VVC, two modes of slices are supported, namely the raster-scan slice mode and the rectangular slice mode. In the raster-scan slice mode, a slice includes a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

In HEVC, a slice consists of an integer number of CTUs. The CTUs are scanned in the raster scan order of CTUs within tiles or within a picture when tiles are not in use. A slice may include an integer number of tiles, or a slice can be contained in a tile.

In some video coding formats, such as AV1, a tile group OBU carries one or more complete tiles. The first and last tiles of in the tile group OBU may be indicated in the tile group OBU before the coded tile data. Tiles within a tile group OBU may appear in a tile raster scan of a picture.

In some video coding formats, such as VVC, a subpicture may be defined as a rectangular region of one or more slices within a picture, wherein the one or more slices are complete. Thus, a subpicture includes one or more slices that collectively cover a rectangular region of a picture. Consequently, each subpicture boundary is also always a slice boundary, and each vertical subpicture boundary is always also a vertical tile boundary. The slices of a subpicture may be required to be rectangular slices. One or both of the following conditions may be required to be fulfilled for each subpicture and tile: i) all CTUs in a subpicture belong to the same tile; ii) All CTUs in a tile belong to the same subpicture.

One or both of the following conditions may be required to be fulfilled for each subpicture and tile: i) All CTUs in a subpicture belong to the same tile. ii) All CTUs in a tile belong to the same subpicture.

An independent VVC subpicture is treated like a picture in the VVC decoding process. Moreover, it may additionally be required that loop filtering across the boundaries of an independent VVC subpicture is disabled. Boundaries of a subpicture are treated like picture boundaries in the VVC decoding process when sps_subpic_treated_as_pic_flag[i] is equal to 1 for the subpicture. Loop filtering across the boundaries of a subpicture is disabled in the VVC decoding process when sps_loop_filter_across_subpic_enabled_pic_flag[i] is equal to 0.

A motion-constrained tile set (MCTS) is such that the inter prediction process is constrained in encoding such that no sample value outside the motion-constrained tile set, and no sample value at a fractional sample position that is derived using one or more sample values outside the motion-constrained tile set, is used for inter prediction of any sample within the motion-constrained tile set. Additionally, the encoding of an MCTS is constrained in a manner that motion vector candidates are not derived from blocks outside the MCTS. This may be enforced by turning off temporal motion vector prediction (TMVP), where TMVP may be specified like in HEVC, for example, or by disallowing the encoder to use the TMVP candidate or any motion vector prediction candidate following the TMVP candidate in a motion vector prediction list, such as the merge or AMVP candidate list as specified in HEVC, for prediction unit located directly left of the right tile boundary of the MCTS except the last one at the bottom right of the MCTS. In general, an MCTS may be defined to be a tile set that is independent of any sample values and coded data, such as motion vectors, that are outside the MCTS. In some cases, an MCTS may be required to form a rectangular area. It should be understood that depending on the context, an MCTS may refer to the tile set within a picture or to the respective tile set in a sequence of pictures. The respective tile set may be, but in general need not be, collocated in the sequence of pictures.

A structure of pictures (SOP) may be defined as one or more coded pictures consecutive in decoding order, in which the first coded picture in decoding order is a reference picture at the lowest temporal sublayer and no coded picture except potentially the first coded picture in decoding order is a random access point picture. All pictures in the previous SOP precede, in decoding order, all pictures in the current SOP; and all pictures in the next SOP succeed, in decoding order, all pictures in the current SOP. A SOP may represent a hierarchical and repetitive inter prediction structure. The term group of pictures (GOP) may sometimes be used interchangeably with the term SOP and having the same semantics as the semantics of SOP.

### Reference Picture Resampling (RPR) and Scaling Window

In reference picture resampling (RPR), which may also be called adaptive resolution change (ARC), the decoding process of a picture may refer to one or more previous reference pictures that have a different spatial resolution for inter prediction. Consequently, a resampling of the reference pictures for operation of the inter-picture prediction process may be applied. In general, resampling may be either picture-wise or block-wise. In picture-wise resampling, an entire reference picture is resampled, whereas in block-wise resampling, an area within a reference picture, such as a reference block for motion compensation, is resampled. The block-wise resampling may be performed as a part of the motion compensation process. Resampling may generally comprise downsampling and upsampling.

VVC enables picture resolution change within a sequence at a position without encoding an IRAP picture, which is always intra-coded in an independent layer. This feature is sometimes referred to as reference picture resampling (RPR), as the feature needs resampling of a reference picture used for inter prediction when that reference picture has a different resolution than the current picture being decoded. In order to avoid additional processing steps, the RPR process in VVC is designed to be embedded in the motion compensation process and performed at the block level. In the motion compensation stage, the scaling ratio is used together with motion information to locate the reference samples in the reference picture to be used in the interpolation process.

In VVC, the scaling ratio is restricted to be larger than or equal to ½ (2 times downsampling from the reference picture to the current picture), and less than or equal to 8 (8 times upsampling). Three sets of resampling filters with different frequency cutoffs are specified to handle various scaling ratios between a reference picture and the current picture. The three sets of resampling filters are applied respectively for the scaling ratio ranging from ½ to 1/1.75, from 1/1.75 to 1/1.25, and from 1/1.25 to 8. Each set of resampling filters has 16 phases for luma and 32 phases for chroma which is the same to the case of motion compensation interpolation filters. It is worthy to note that the filter set of normal motion compensation (MC) interpolation is used in the case of scaling ratio ranging from 1/1.25 to 8. Actually, the normal MC interpolation process is a special case of the resampling process with scaling ratio ranging from 1/1.25 to 8. The horizontal and vertical scaling ratios are derived based on picture width and height, and the left, right, top and bottom scaling offsets specified for the reference picture and the current picture. Scaling window for each picture is calculated by adding the scaling offset to the picture size. Then the scaling ratio is derived by dividing the scaling window on the reference frame to that of the current frame.

A scaling window may be signaled for and associated with a picture. Scaling windows of a picture and its reference picture may indicate the spatial correspondence between the pictures. Scaling windows may be used to achieve one or both of the following: i) a horizontal scaling ratio and a vertical scaling ratio may be derived based on the width ratio and the height ratio, respectively, of the scaling windows; ii) a left offset and a top offset for inter prediction may be derived. The horizontal and vertical scaling ratios may be used as resampling ratios for RPR. The left and top offsets may be used in deriving a spatial correspondence between a picture and its reference picture. The left and top offsets may be added in the reference picture location derivation through a motion vector scaled by a scaling ratio. For example, the top-left corner of the current block is mapped to the respective ‘anchor location’ in the reference picture through the left and top offsets, and a motion vector scaled by a scaling ratio is then applied to obtain a reference block in relation to anchor location. In general, the scaling ratio may be 1:1, in which case the left and top offsets may be applied without resampling. It needs to be understood that there may be other means to signal scaling ratio(s), top offset, and/or left offset than scaling windows.

In VVC, a scaling window may be indicated in a PPS explicitly or implicitly. When indicated explicitly, pps_scaling_win_left_offset, pps_scaling_win_right_offset, pps_scaling_win_top_offset, and pps_scaling_win_bottom_offset specify the offsets of the scaling window boundaries relative to the left, right, top, and bottom boundaries of the conformance cropping window, respectively. When indicated implicitly, the scaling window is inferred to be identical to the conformance cropping window.

A decoder and/or a hypothetical reference decoder (HRD) of a video coding specification may comprise a picture output process. The output process may be considered to be a process in which the decoder provides decoded and cropped pictures as the output of the decoding process. The output process may be a part of video coding standards, e.g., as a part of the hypothetical reference decoder specification. In output cropping, lines and/or columns of samples may be removed from decoded pictures according to a cropping rectangle to form output pictures. A cropped decoded picture may be defined as the result of cropping a decoded picture based on the conformance cropping window specified, e.g., in the sequence parameter set that is referred to by the corresponding coded picture. Hence, it may be considered that the conformance cropping window specifies the cropping rectangle to form output pictures from decoded pictures.

In order to support of RPR in VVC, the picture resolution and the corresponding conformance window are signaled in the PPS instead of in the SPS, while in the SPS the maximum picture resolution is signaled.

### Scalable Video Coding

Scalable video coding may refer to coding structure where one bitstream may include multiple representations of the content, for example, at different bitrates, resolutions or frame rates. In these cases the receiver can extract the desired representation depending on its characteristics (e.g., resolution that matches best the display device). Alternatively, a server or a network element may extract the portions of the bitstream to be transmitted to the receiver depending on, e.g., the network characteristics or processing capabilities of the receiver. A meaningful decoded representation may be produced by decoding only certain parts of a scalable bitstream. A scalable bitstream typically include of a ‘base layer’ providing the lowest quality video available and one or more enhancement layers that enhance the video quality when received and decoded together with the lower layers. In order to improve coding efficiency for the enhancement layers, the coded representation of that layer typically depends on the lower layers. For example, the motion and mode information of the enhancement layer can be predicted from lower layers. Similarly, the pixel data of the lower layers can be used to create prediction for the enhancement layer.

A scalable bitstream may include a ‘base layer’ providing the lowest quality video available and one or more enhancement layers that enhance the video quality when received and decoded together with the lower layers. In order to improve coding efficiency for the enhancement layers, the coded representation of that layer may depend on the lower layers. E.g., the motion and mode information of the enhancement layer may be predicted from lower layers. Similarly, the pixel data of the lower layers can be used to create prediction for the enhancement layer.

A scalable video codec for quality scalability (also known as signal-to-noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use, e.g., with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

It needs to be understood that the description of scalable video coding may be generalized to any two scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the decoded picture buffer (DPB). An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, if any. In addition to reconstructed/decoded sample values, syntax element values of the base/reference layer or variables derived from the syntax element values of the base/reference layer may be used in the inter-layer/inter-component/inter-view prediction.

Inter-layer prediction may be defined as prediction in a manner that is dependent on data elements (e.g., sample values or motion vectors) of reference pictures from a different layer than the layer of the current picture (being encoded or decoded). Many types of inter-layer prediction exist and may be applied in a scalable video encoder/decoder.

The types of inter-layer prediction may comprise, but are not limited to, one or more of the following: inter-layer sample prediction, inter-layer motion prediction, inter-layer residual prediction. In inter-layer sample prediction, at least a subset of the reconstructed sample values of a source picture for inter-layer prediction are used as a reference for predicting sample values of the current picture. In inter-layer motion prediction, at least a subset of the motion vectors of a source picture for inter-layer prediction are used as a reference for predicting motion vectors of the current picture. Typically, predicting information on which reference pictures are associated with the motion vectors is also included in inter-layer motion prediction. For example, the reference indices of reference pictures for the motion vectors may be inter-layer predicted and/or the picture order count or any other identification of a reference picture may be inter-layer predicted. In some cases, inter-layer motion prediction may also comprise prediction of block coding mode, header information, block partitioning, and/or other similar parameters. In some cases, coding parameter prediction, such as inter-layer prediction of block partitioning, may be regarded as another type of inter-layer prediction. In inter-layer residual prediction, the prediction error or residual of selected blocks of a source picture for inter-layer prediction is used for predicting the current picture.

A direct reference layer may be defined as a layer that may be used for inter-layer prediction of another layer for which the layer is the direct reference layer. A direct predicted layer may be defined as a layer for which another layer is a direct reference layer. An indirect reference layer may be defined as a layer that is not a direct reference layer of a second layer but is a direct reference layer of a third layer that is a direct reference layer or indirect reference layer of a direct reference layer of the second layer for which the layer is the indirect reference layer. An indirect predicted layer may be defined as a layer for which another layer is an indirect reference layer. An independent layer may be defined as a layer that does not have direct reference layers. In other words, an independent layer is not predicted using inter-layer prediction. A non-base layer may be defined as any other layer than the base layer, and the base layer may be defined as the lowest layer in the bitstream. An independent non-base layer may be defined as a layer that is both an independent layer and a non-base layer.

A multi-layer bitstream is a bitstream comprising multiple layers, which may be, but are not limited to, base and enhancement layers as discussed above for scalable video coding. A multi-layer bitstream may additionally or alternatively comprise independent layers that do not have inter-layer prediction relationship between each other and may even represent different types of content.

Scalability modes or scalability dimensions may include, but are not limited, to one or more of the following:
Quality scalability: Base layer pictures are coded at a lower quality than enhancement layer pictures, which may be achieved, for example, by using a greater quantization parameter value (e.g., a greater quantization step size for transform coefficient quantization) in the base layer than in the enhancement layer.
Spatial scalability: Base layer pictures are coded at a lower resolution (e.g., have fewer samples) than enhancement layer pictures. Spatial scalability and quality scalability may sometimes be considered the same type of scalability.
Bit-depth scalability: Base layer pictures are coded at lower bit-depth (e.g., 8 bits) than enhancement layer pictures (e.g., 10 or 12 bits).
Dynamic range scalability: Scalable layers represent a different dynamic range and/or images obtained using a different tone mapping function and/or a different optical transfer function.
Chroma format scalability: Base layer pictures provide lower spatial resolution in chroma sample arrays (e.g., coded in 4:2:0 chroma format) than enhancement layer pictures (e.g., 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
Region-of-interest (ROI) scalability: An enhancement layer represents a spatial subset of the base layer. ROI scalability may be used together with other types of scalabilities, e.g., quality or spatial scalability so that the enhancement layer provides higher subjective quality for the spatial subset.
View scalability, which may also be referred to as multiview coding. In an example, the base layer represents a first view or a first camera, whereas an enhancement layer represents a second view or a second camera. In another example, the base layer represents a first set of views, which may be for example frame-packed, whereas an enhancement layer represents a second set of views.
Depth scalability, which may also be referred to as depth-enhanced coding. A layer or some layers of a bitstream may represent texture view(s), while other layer or layers may represent depth view(s).

In all of the above scalability examples, base layer information may be used to code enhancement layer to minimize the additional bitrate overhead.

Scalability may be enabled in two example ways. Either by introducing new coding modes for performing prediction of pixel values or syntax from lower layers of the scalable representation; or by placing the lower layer pictures to the reference picture buffer (decoded picture buffer, (DPB)) of the higher layer. The first approach (coding modes) is more flexible and thus may provide better coding efficiency in most cases. The reference frame-based scalability approach may be implemented more efficiently with minimal changes to single layer codecs, as compared to the first approach, while still achieving majority of the coding efficiency gains available. For example, a reference frame-based scalability codec may be implemented by utilizing the same hardware or software implementation for all the layers, by simply managing of the DPB management by external means.

In ROI scalability, spatial correspondence of an ROI enhancement layer in relation to its reference layer(s) is indicated. In VVC, scaling windows can be used to indicate this spatial correspondence.

It has been proposed, e.g., in JVET-O1150 (https://www.jvet-experts.org/doc_end_user/documents/15_Gothenburg/wg11/JVET-O1150-v2.zip; last accessed on Mar. 14, 2023), that temporal sublayers may be used for any type of scalability. A mapping of scalability dimensions to sublayer identifiers could be provided, e.g., in a VPS or in an SEI message.

### Region-of-Interest-Based Processing

For an application where image/video coding is applied, some regions of the input frame may include important information for the system, while other regions are less important. The regions that are important for the system may be referred to as regions of interest (ROIs) or foreground regions. Background regions or regions other than the foreground regions may be referred to as non-ROIs. For instance, when the system performs an object detection task, ROIs may include objects that are supposedly detected by the object detection task network.

In conventional image/video codecs, a frame may be partitioned into processing blocks, for example, coding tree unit (CTU) and coding unit (CU). The rate-distortion trade-off of each processing block may be controlled by parameters, such as the quantization parameter (QP). For processing units that fall into the ROI or overlap significantly with the ROI, encoding parameters that achieve high reconstruction quality may be applied.

Given the information of the ROIs as input, the encoder may encode the ROIs with higher qualities while encoding the non-ROIs with lower qualities. ROI-based encoding may refer to an encoding process, where only some region(s) of an image or a frame are encoded with a high-quality, while rest of the image or the frame is encoded with lower quality. The term “quality” in relation to ROI-based coding does not necessarily mean quality as perceived by human beings, and may additionally or alternatively mean “quality” as analyzed by a machine task, wherein higher quality may, for example, imply a higher machine analysis precision and lower quality may, for example, imply a lower machine analysis precision.

Any ROI detection method may be used together with the present embodiments for encoding. There are alternatives to detect regions of interest in the image or the frame, which comprise, e.g., usage of task neural networks, feature-based algorithms, object-based algorithms, saliency-based algorithms, or their combination. For example, ROI detection may be performed using a task NN, such as an object detection NN or an instance segmentation NN. Additionally or alternatively, in another example, an object tracking method or an object tracking NN may be used to detect ROIs.

Some ROI detection methods may provide a rectangular bounding box that includes one or more ROIs. Other ROI detection methods may provide boundaries of a region that may be non-rectangular. In the latter case, a bounding box that encloses the detected ROI region may be regarded as the ROI in some embodiments.

### Frame Packing

Frame packing may be defined to comprise arranging more than one input picture, which may be referred to as (input) constituent frames, into an output picture, or arranging the input pictures as a temporal interleaving of alternating first and second constituent frames.

A constituent frame parity may be defined as a first constituent frame or a second constituent frame, or equivalent as constituent frame 0 or constituent frame 1.

In general, frame packing is not limited to any particular type of constituent frames or the constituent frames need not have a particular relation with each other. In many cases, frame packing is used for arranging constituent frames of a stereoscopic video clip into a single picture sequence, as explained in more details in the next paragraph. The arranging may include placing the input pictures in spatially non-overlapping areas within the output picture. For example, in a side-by-side arrangement, two input pictures are placed within an output picture horizontally adjacently to each other. The arranging may also include partitioning of one or more input pictures into two or more constituent frame partitions and placing the constituent frame partitions in spatially non-overlapping areas within the output picture. The output picture or a sequence of frame-packed output pictures may be encoded into a bitstream, e.g., by a video encoder. The bitstream may be decoded e.g. by a video decoder. The decoder or a post-processing operation after decoding may extract the decoded constituent frames from the decoded picture(s), e.g., for displaying.

In frame-compatible stereoscopic video (e.g., frame packing of stereoscopic video), a spatial packing of a stereo pair into a single frame is performed at the encoder side as a pre-processing step for encoding and then the frame-packed frames are encoded with a conventional 2D video coding scheme. The output frames produced by the decoder contain constituent frames of a stereo pair.

In a typical operation mode, the spatial resolution of the original frames of each view and the packed single frame have the same resolution. In this case the encoder downsamples the two views of the stereoscopic video before the packing operation. The spatial packing may use for example a side-by-side or top-bottom format, and the downsampling should be performed accordingly.

An encoder may indicate the use of frame packing by including one or more frame packing arrangement SEI messages, e.g. as defined in VSEI, in the bitstream. Likewise, a decoder may conclude the use of frame packing by decoding one or more frame packing arrangement SEI messages from the bitstream. When a frame packing arrangement SEI message applies to the current coded layer video sequence (CLVS), a cropped decoded picture contains samples of multiple distinct spatially packed constituent frames that are packed into one frame, or the output cropped decoded pictures in output order form a temporal interleaving of alternating first and second constituent frames, using an indicated frame packing arrangement scheme. This information can be used by the decoder to appropriately rearrange the samples and process the samples of the constituent frames appropriately for display or other purposes.

A frame packing arrangement SEI message may comprise a content interpretation type syntax element, which may be named fp_content_interpretation_type. The content interpretation type syntax element may indicate the intended interpretation of the constituent frames. For example, a first content interpretation type value may indicate that the two constituent frames form the left and right views of a stereo view scene, with constituent frame 0 being associated with the left view and constituent frame 1 being associated with the right view, and a second content interpretation type value may indicate that the two constituent frames form the right and left views of a stereo view scene, with constituent frame 0 being associated with the right view and constituent frame 1 being associated with the left view

In some video codecs, video usability information (VUI) may be included in a sequence parameter set (SPS). VUI specified in VSEI comprises the following:
vui_non_packed_constraint_flag equal to 1 specifies that there shall not be any frame packing arrangement SEI messages present in the bitstream that apply to the CLVS. vui_non_packed_constraint_flag equal to 0 does not impose such a constraint.

Inter-view sample prediction between spatially frame-packed constituent frames may be enabled with the intra block copy tool as follows. A first constituent frame representing a first view and a second constituent frame representing a second view of the same multiview (e.g., stereoscopic) content are frame-packed. Intra-block-copy prediction from the first constituent frame to the second constituent frame is enabled in encoding, but intra-block-copy prediction from the second constituent frame to the first constituent frame is disabled in encoding. Hence, inter-view sample prediction is essentially achieved by applying intra-block-copy prediction between constituent frames of different views. Compression efficiency is hence improved compared to coding of frame-packed multiview content without intra-block-copy prediction.

### Neural-Network Post-Filter Characteristics (NNPFC) and Neural-Network Post-Filter Activation (NNPFA) SEI Messages

The neural-network post-filter characteristics (NNPFC) SEI message and the neural-network post-filter activation (NNPFA) SEI message have been described in document JVET-AC2032.

The NNPFC SEI message comprises the nnpfc_id syntax element, which includes an identifying number that may be used to identify a post-processing filter. A base post-processing filter is the filter that is included in or identified by the first NNPFC SEI message, in decoding order, that has a particular nnpfc_id value within a coded layer video sequence (CLVS). An NNPFC SEI message may define an update relative to the base post-processing filter for the same nnpfc_id value. When there is a second NNPFC SEI message that is neither the first NNPFC SEI message, in decoding order, in the current CLVS nor a repetition of the first NNPFC SEI message, in decoding order, that has a particular nnpfc_id value within the current CLVS, the second NNPFC SEI message defines an update relative to the base post-processing filter. The update may be obtained by decoding the coded neural network bitstream in the second NNPFC SEI message (when nnpfc_mode_idc is equal to 0) or through the Uniform Resource Identifier defining the update (when nnpfc_mode_idc is equal to 1). Otherwise (e.g., when there is no update defined by an NNPFC SEI message), the post-processing filter associated with the nnpfc_id value is assigned to be the same as the base post-processing filter.

The NNPFC SEI message comprises nnpfc_mode_idc syntax element, the semantics of which may be defined as follows:
nnpfc_mode_idc equal to 1 specifies that the base post-processing filter or the update relative to the base post-processing filter associated with the nnpfc_id value is a neural network identified by the Uniform Resource Identifier (URI) nnpfc_uri with the format identified by the tag URI nnpfc_tag_uri.
nnpfc_mode_idc equal to 0 indicates that this SEI message contains an ISO/IEC 15938-17 bitstream that specifies the base post-processing filter or updates relative to the base post-processing filter with the same nnpfc_id value.

### The NNPFC SEI Message May Also Comprise:

Purpose of the post-processing filter, which may comprise one or more of the following:
   Visual quality improvement
   Chroma upsampling from the 4:2:0 chroma format to the 4:2:2 or 4:4:4 chroma format, or from the 4:2:2 chroma format to the 4:4:4 chroma format
   Increasing the width or height
   Frame rate upsampling
   Bit depth upsampling
   Colorization
Formatting of the input tensors that are given as input to the neural network inference
Formatting of the output tensors that are resulting from the neural network inference
Characterization of the complexity of the neural network

A frame rate upsampling filter may interchangeably be called a picture rate upsampling filter. Such a filter generates or interpolates one or more pictures between a pair of pictures given as input to the filter. It is also possible to have a frame rate upsampling filter where the number of input pictures may be greater than 2. Such a frame rate upsampling filter may generate pictures between more than one pair of input pictures. A frame rate upsampling filter may comprise a neural network, in which case the generation of the interpolated pictures between a pair of input pictures is performed by the inference of the neural network. It is possible to have a frame rate upsampling filter that extrapolates a picture before input picture(s) or after input picture(s) instead of or in addition to between input pictures.

When the filtering purpose comprises frame rate upsampling, the NNPFC SEI message includes nnpfc_interpolated_pics[i] syntax elements for the value sof i in the range of 0, inclusive, to nnpfc_num_input_pics_minus1, exclusive. nnpfc_num_input_pics_minus1 plus 1 specifies the number of pictures used as input for the NNPF and may be present regardless of the filtering purpose. The variable numInputPics may be set equal to nnpfc_num_input_pics_minus1+1. nnpfc_interpolated_pics[i] specifies the number of interpolated pictures generated by the NNPF between the i-th and the (i+1)-th picture used as input for the NNPF.

The NNPFA SEI message specifies the neural-network post-processing filter that may be used for post-processing filtering for the current picture, or for post-procssing filtering for the current picture and one or more other pictures. The NNPFA SEI message comprises the nnpfa_target_id syntax element, which indicates that the neural-network post-processing filter with nnpfc_id equal to nnfpa_target_id may be used for post-processing filtering for the indicated persistence. The indicated persistence may be the current picture only (nnpfa_persistence_flag equal to 0), or until the end of the current CLVS or the next picture, in output order, in the current layer associated with a NNPFA SEI message with the same nnpfa_target_id as the current SEI message (nnpfa_persistence_flag equal to 1).

### Annotated Regions SEI Message

The annotated regions SEI message has been specified in the VSEI standard (ISO/IEC 23002-7|ITU-T H.274) as well as in HEVC (ISO/IEC 23008-2|ITU-T H.265). In the following, the syntax element names refer to the VSEI definition of the annotated regions SEI message.

The annotated regions SEI message carries parameters that identify annotated regions using bounding boxes representing the size and location of identified objects.

The annotated regions SEI message may comprise, but may not be limited to, one or more pieces of the following information:
ar_not_optimized_for_viewing_flag equal to 1 indicates that the decoded pictures that the annotated regions SEI message applies to are not optimized for user viewing, but rather are optimized for some other purpose such as algorithmic object classification performance. ar_not_optimized_for_viewing_flag equal to 0 indicates that the decoded pictures that the annotated regions SEI message applies to may or may not be optimized for user viewing.
ar_true_motion_flag equal to 1 indicates that the motion information in the coded pictures that the annotated regions SEI message applies to was selected with a goal of accurately representing object motion for objects in the annotated regions. ar_true_motion_flag equal to 0 indicates that the motion information in the coded pictures that the annotated regions SEI message applies to may or may not have been selected with a goal of accurately representing object motion for objects in the annotated regions.
ar_occluded_object_flag equal to 1 indicates that each of the bounding boxes represents the size and location of an object or a portion of an object that may not be visible or may be only partially visible within the cropped decoded picture that the annotated regions SEI message applies to. ar_occluded_object_flag equal to 0 indicates that each of the bounding boxes represents the size and location of an object that is entirely visible within the cropped decoded picture that the annotated regions SEI message applies to.
Textual labels, which are assigned indices.
A language used in the labels.
A mapping of an object to a label index.
A bounding box of an object.
An indication of whether the bounding box represents the size and location of an object that is only partially visible within the cropped decoded picture.
A degree of confidence associated with an object.

### Regional Nesting SEI Message

The regional nesting SEI message has been specified in the H.265/HEVC standard. The regional nesting SEI message provides a mechanism to associate SEI messages with regions of the picture. The associated SEI messages are conveyed within the regional nesting SEI message.

A regional nesting SEI message includes one or more SEI messages. When an SEI message is included in a regional nesting SEI message, the included SEI message may be referred to as a region-nested SEI message. When an SEI message is not included in a regional nesting SEI message, the SEI message may be referred to as a non-region-nested SEI message.

For each region-nested SEI message in a regional nesting SEI message, one or more regions are specified in the regional nesting SEI message, and the semantics of the region-nested SEI message are to be interpreted as applying to each of these regions.

When an access unit includes both region-nested SEI messages of a particular type and non-region-nested SEI messages of the same type, decoders may choose to ignore either all the region-nested SEI message of that type or all the non-region-nested SEI messages of that type.

The regional nesting SEI message may comprise, but may not be limited to, one or more pieces of the following information:
the number of rectangular regions (regional_nesting_num_rect_regions)
an identifier for each rectangular region specified in the regional nesting SEI message
the bounding box coordinates of each rectangular region
the number of region-nested SEI messages in the regional nesting SEI message
the number of regions for each region-nested SEI message
for each region-nested SEI message, the indices (regional_nesting_sei_region_idx[i][j]), into the list of regions specified in the regional nesting SEI message, that specify the regions that the region-nested SEI message applies

In an example, an NNPFA SEI message included in a regional nesting SEI message indicates that the neural-network post-filtering is to be applied for each of the regions indicated by the regional nesting SEI message. For the semantics of the NNPFC SEI message, the following variables are specified. The variables CroppedWidth and CroppedHeight are set according to the region width and height, respectively. The variables CroppedYPic[i], CroppedCbPic[i] and CroppedCrPic[i] are the indicated region of the Y, Cb, and Cr sample arrays of the i-th cropped decoded output picture used as input for the post-processing filter.

### Region-Wise Packing SEI Message

The region-wise packing SEI message has been specified in the VSEI standard, for example. The region-wise packing SEI message provides is intended to be used with omnidirectional projected video content and provides information to enable remapping of the colour samples of the cropped decoded pictures onto projected pictures. Positions and sizes of rectangular areas on the cropped decoded picture and their respective positions and sizes on the projected picture are indicated in the region-wise packing SEI message, thus enabling to re-position and resample rectangular areas of the cropped decoded picture onto the projected picture that complies with an omnidirectional projection format. While the region-wise packing SEI message is intended to be used with omnidirectional projected video content, the SEI message or any similar SEI message could be used for rectangular region-wise remapping of any video content.

### Information on Video Coding for Machines (VCM)

Reducing the distortion in image and video compression is often intended to increase human perceptual quality, as humans are considered to be the end users, e.g. consuming or watching the decoded images or videos. Recently, with the advent of machine learning, especially deep learning, there is a rising number of machines (e.g., autonomous agents) that analyze or process data independently from humans and may even take decisions based on the analysis results without human intervention. Examples of such analysis are object detection, scene classification, semantic segmentation, video event detection, anomaly detection, pedestrian tracking, and the like. Example use cases and applications are self-driving cars, video surveillance cameras and public safety, smart sensor networks, smart TV and smart advertisement, person re-identification, smart traffic monitoring, drones, and the like. Accordingly, when decoded data is consumed by machines, a quality metric for the decoded data may be defined, which may be different from a quality metric for human perceptual quality. Also, dedicated algorithms for compressing and decompressing data for machine consumption may be different than those for compressing and decompressing data for human consumption. The set of tools and concepts for compressing and decompressing data for machine consumption is referred to here as Video Coding for Machines.

It is likely that the receiver-side device include multiple ‘machines’ or neural networks (NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

Also, the term ‘receiver-side’ or ‘decoder-side’ to refer to the physical or abstract entity or device which includes one or more machines, and runs these one or more machines on some encoded and eventually decoded video representation which is encoded by another physical or abstract entity or device, the ‘encoder-side device’.

The encoded video data may be stored into a memory device, for example as a file. The stored file may later be provided to another device.

Alternatively, the encoded video data may be streamed from one device to another.

FIG. 3 illustrates a pipeline of video coding for machines (VCM), in accordance with an embodiment. A VCM encoder 302 encodes the input video into a bitstream 304. A bitrate 306 may be computed 308 from the bitstream 304 in order to evaluate the size of the bitstream 304. A VCM decoder 310 decodes the bitstream 304 output by the VCM encoder 302. An output of the VCM decoder 310 may be referred, for example, as decoded data for machines 312. This data may be considered as the decoded or reconstructed video. However, in some implementations of the pipeline of VCM, the decoded data for machines 312 may not have same or similar characteristics as the original video which was input to the VCM encoder 302. For example, this data may not be easily understandable by a human, when the human watches the decoded video from a suitable output device such as a display. The output of the VCM decoder 310 is then input to one or more task neural network (task-NN). For the sake of illustration, FIG. 3 is shown to include three example task-NNs, a task-NN 314 for object detection, a task-NN 316 for image segmentation, a task-NN 318 for object tracking, and a non-specified one, a task-NN 320 for performing task X. The goal of VCM is to obtain a low bitrate while guaranteeing that the task-NNs still perform well in terms of the evaluation metric associated with each task.

When a conventional video encoder, such as a H.266/VVC encoder, is used as a VCM encoder, one or more of the following approaches may be used to adapt the encoding to be suitable to machine analysis tasks:
One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:
   The quantization parameter (QP) may be adjusted spatially in a manner that ROIs are encoded using finer quantization step size(s) than other regions. For example, QP may be adjusted CTU-wise.
   The video is preprocessed to contain only the ROIs, while the other areas are replaced by one or more constant values or removed.
   A grid is formed in a manner that a single grid cell covers a ROI. Grid rows or grid columns that contain no ROIs are downsampled as preprocessing to encoding.
Quantization parameter of the highest temporal sublayer(s) is increased (i.e. coarser quantization is used) when compared to practices for human watchable video.
The original video is temporally downsampled as preprocessing prior to encoding. A frame rate upsampling method may be used as postprocessing subsequent to decoding, if machine analysis at the original frame rate is desired.
A filter is used to preprocess the input to the conventional encoder. The filter may be a machine learning based filter, such as a convolutional neural network.

As non-limiting examples, various embodiments aim at improving ROI-based video coding for machines, where the base video codec may be a conventional video codec, such as H.266/VVC. Following are some example problems that one or more embodiments address:
As compared to existing prior art, are there means to compress ROIs better in terms of machine analysis precision than the remaining regions?
Are there means to compress a bitstream so that a decoder can decode either or both of a first decoded version for user viewing and a second decoded version with improved machine analysis precision for ROIs?

In an embodiment, an example method for encoding is described. The example method for encoding comprises:
obtaining a video sequence;
obtaining information on one or more regions of interest (ROIs) in the video sequence;
arranging the one or more ROIs of a first set of timestamps into a first constituent frame sequence;
arranging other regions (non-ROIs) or content frames of a second set of timestamps in a second constituent frame sequence, wherein the second set of timestamps at least partially differs from the first set of timestamps (e.g., at least one timestamp in the second set of timestamps is different from the timestamps in the first set of timestamps); and
encoding the first constituent frame sequence and the second constituent frame sequence into a bitstream.

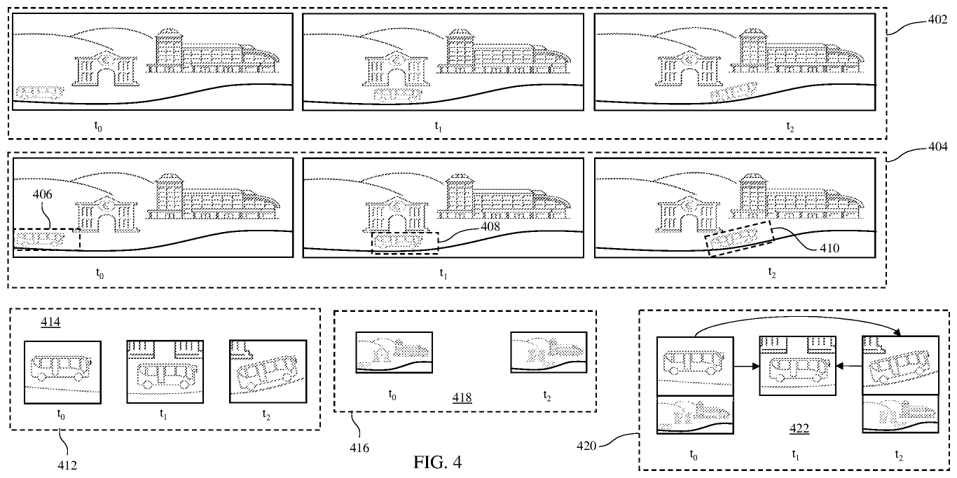

FIG. 4 illustrates an example of encoding, in accordance with an embodiment. 402 illustrates obtaining a video sequence at timestamps t₀, t₁, and t₂. 404 illustrates obtaining information on ROIs (e.g., ROIs 406, 408, and 410 at timestamps t₀, t₁, and t₂ respectively) in the video sequence. 412 illustrates arranging the ROIs of a first set of timestamps (t₀, t₁, t₂) into a first constituent frame sequence 414. 416 illustrates arranging content frames (by downsampling) of a second set of timestamps (t₀, t₂) in a second constituent frame sequence 418. 420 illustrates encoding the first constituent frame sequence 414 and the second constituent frame sequence 418 into a bitstream 422. Coinciding constituent frame boundaries indicate spatial arrangement of the first and second constituent frames 414, 418 into a same frame to be encoded. Arrows illustrate an example of inter prediction, where an arrow points to the predicted frame from the reference frame used as a source for prediction.

Some example non-limiting benefits of the method include:
Sample rate (i.e., pixel rate) is reduced and compression ratio is improved, since
   i. non-ROIs or content frames can be coded at a lower spatial resolution,
   ii. the first or second constituent frame sequence has a lower frame rate compared to the original frame rate.
Machine analysis precision is expected to be high, since ROIs are coded with high fidelity.

In another embodiment, an example method for decoding is described. The example method for decoding comprises:
decoding a bitstream into a decoded frame sequence;
identifying a first constituent frame sequence and a second constituent frame sequence from the decoded frame sequence, wherein
   the first constituent frame sequence corresponds to a first set of timestamps,
   the second constituent frame sequence corresponds to a second set of timestamps, and
   the second set of timestamps at least partially differs from the first set of timestamps;
fusing the first constituent frame sequence and the second constituent frame sequence into a composed video sequence corresponding to a union of the first and second sets of timestamps.

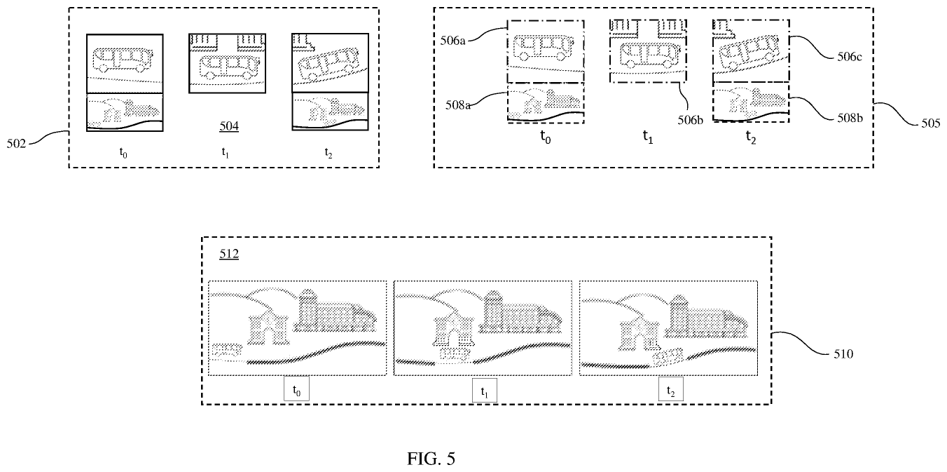

FIG. 5 illustrates an example decoding, in accordance with an embodiment. Taking the bitstream of the example of FIG. 4, an example of decoding is presented below with decoding steps described as above. 502 illustrates decoding a bitstream 422 into a decoded frame sequence 504. 505 illustrates identifying a first constituent frame sequence (e.g., first constituent frames 506a, 506b, and 506c) and a second constituent frame sequence (e.g., second constituent frames 508a and 508b) from the decoded frame sequence 504. 510 illustrates fusing the first constituent frame sequence and the second constituent frame sequence into a composed video sequence 512 corresponding to a union of the first and second constituent frame sequences. In this example, the fusing comprises generating a constituent frame at t1 for the second constituent frame sequence (described below for methods for generating), upsampling second constituent frames, and superimposing first constituent frames on top of upsampled second constituent frames.

### Packing of Constituent Frames

An example constituent frame may be defined as:
a rectangular region within a frame that includes one or more other constituent frames (example 1);
a frame within two or more adjacent frames, in output order, that correspond to the same display timestamp (example 2); or
a first frame in an access unit that also comprises other frame(s) originating from the same source frame as the first frame, wherein the first frame and the other frame(s) reside in different scalability layers (example 3).

An example constituent frame sequence may be defined as a sequence of the corresponding constituent frames within a frame sequence, wherein corresponding constituent frames may be:
spatially collocated (for example 1 above);
in the same position within the two or more adjacent frames, in output order, that correspond to the same display timestamp (for example 2 above);
frames in different scalability layers in the same access unit (for example 3 above); or
frames in different bitstreams, where the bitstreams may be associated with each other, e.g., using means in a container file format (such as ISO base media file format) or media description format (such as IETF Session Description Protocol or DASH Media Presentation Description).

A content frame may correspond to a captured image. A content frame may be considered to enclose an entire source frame. A content frame may be encoded as constituent frame.

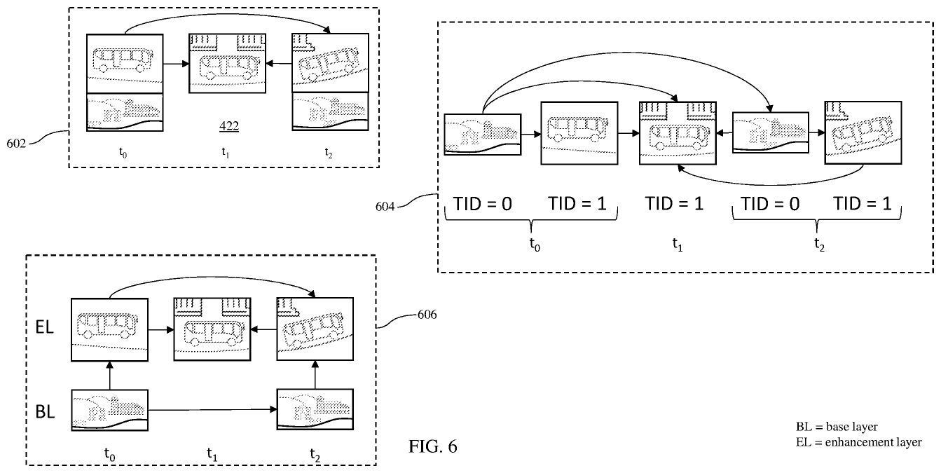

FIG. 6 illustrates various examples of packing a first constituent frame sequence comprising ROIs and a second constituent frame sequence representing content frames. 602 illustrates spatial packing. 604 illustrates temporal interleaving. 606 illustrates multi-layer coding. In these examples, the frame rate of the first constituent frame sequence is higher than the frame rate of the second constituent frame sequence.

It is to be understood that the embodiments are not limited to the examples presented above. For example, embodiments may be realized with any of the following modifications compared to the presented examples:
A second constituent frame sequence may represent non-ROIs. For example, ROIs may have been removed and replaced with a constant color or smoothly interpolated from the surrounding pixels.
The frame rate of the first constituent frame sequence may be lower than the frame rate of the second constituent frame sequence.
The second constituent frame sequence may be predicted from the first constituent frame sequence. For example, when scalability layers are in use, ROIs may be in the base layer and content frames in the enhancement layer. In another example, when temporal interleaving is in use, a constituent frame comprising ROI(s) may precede the respective constituent frame comprising non-ROIs or the content frame in decoding order, and the content frame may be predicted based at least on the ROI(s).
The second constituent frame sequence may be independently coded from the first constituent frame sequence, e.g., there is no prediction between the first and second constituent frame sequences.
The relative spatial resolution of the second constituent frames may be equal to that of the first constituent frames, and the second constituent frames or regions of the second constituent frames may be preprocessed and/or encoded to be of lower quality compared to the quality of the first constituent frames.

In an embodiment, a first video bitstream represents the first constituent frame sequence and a second bitstream represents the second constituent frame sequence. The video bitstreams may comply with the same coding format or may comply with different coding formats. Constituent frames of different bitstreams may be associated with each other for example through timestamps carried in the packet format or the container file format.

### Indicating Spatial Packing

A region-wise packing SEI message or alike may be used to define regions within a decoded frame and their location and scale in a composed picture. Additionally, a layering order of regions may be defined in the region-wise packing SEI message or alike. A content interpretation type or alike may be included in the region-wise packing SEI message or alike to indicate that the packed frame comprises regions that are ROIs that are coded at higher resolution and/or fidelity and overlaid on top of or adjacent to background region(s).

### Inter Prediction in Spatial Packing

Prediction from a second constituent frame to a first constituent frame of a different timestamp or vice versa can be enabled through reference picture resampling, as defined in VVC. Reference picture resampling uses scaling windows which can be used, for example, for locating the first constituent frame within the area of the second constituent frame.

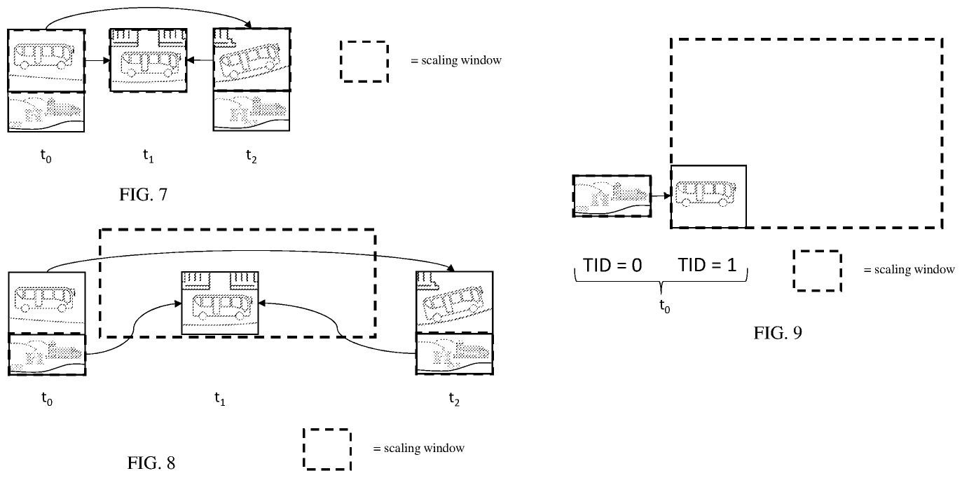

This paragraph describes an embodiment that applies when a frame either comprises a first constituent frame comprising an ROI and a second constituent frame comprising a content frame; or just a first constituent frame comprising an ROI. A scaling window, as defined in VVC, is encoded for each frame in the bitstream, and the scaling window matches with the ROI boundaries within each frame. An example of this embodiment is described in FIG. 7.

FIG. 7 illustrates an example usage of scaling windows for indicating spatial correspondence for inter prediction in spatial packing, in accordance with an embodiment. In the example presented above, the picture t1 is predicted from respective ROIs of t0 and t2, the ROI in t2 is predicted from the ROI in t0, and the content frame in t2 is predicted from the content frame in to.

This paragraph and following paragraph describe an embodiment that applies when a frame either comprises a first constituent frame comprising an ROI and a second constituent frame comprising a content frame, or just a first constituent frame comprising an ROI. A scaling window, as defined in VVC, is encoded for each frame in the bitstream and the scaling window matches with the content frame boundaries within each frame. An example of this embodiment is described in FIG. 8.

FIG. 8 illustrates an example usage of scaling windows for indicating spatial correspondence for inter prediction in spatial packing, in accordance with another embodiment. In this example, the scaling window may cover a small-resolution content frame in t0 and t2 and the content frame boundaries that would include the high-resolution bus in t1. Consequently, the picture t1 is then predicted from respective small-resolution areas in t0 and t2.

In an embodiment, a decoder infers that a picture contains only ROIs, when its scaling window (as defined in VVC) is larger than the picture boundaries.

### Indicating Temporal Interleaving

In an embodiment, a frame packing arrangement SEI message is encoded to indicate temporal interleaving of alternating first and second constituent frames and a new content interpretation type of the frame packing arrangement SEI message is defined to indicate that frame 1 is ROI(s) of frame 0 with higher fidelity and/or resolution. With the VSEI syntax of the frame packing arrangement SEI message, fp_arrangement_type may be set to 5 (temporal interleaving of alternating first and second constituent frames) and a new value of fp_content_interpretation_type (e.g., value 3) is defined and used.

In an embodiment, the spatial correspondence of frame 1 in relation to frame 0 is obtained through scaling windows of frame 0 and frame 1 (as described in the ‘Inter prediction in temporal interleaving’ section below).

In an embodiment, the spatial correspondence of ROIs in frame 1 in relation to frame 0 is obtained through annotated regions SEI messages or alike. Frame 1 of each pair of constituent frames may contain multiple ROIs in spatially packed manner. An annotated regions SEI message is included in both frame 0 and frame 1, and the ar_object_idx[i] values in frame 1 shall have a matching ar_object_idx[i] value in frame 0. The bounding box for objects in frame 0 indicates the position within frame 0 for the object with the same index in frame 1. It is to be understood that ar_object_idx[i] value may likewise be any object or region identifier syntax element.

In an embodiment, each ROI is encoded in an independent subpicture, an MCTS, or the like when the size of the ROI is approximately stable for a period of pictures, such as a CLVS or a CVS, and the size can be rounded up to integer multiples of CTU width and height, and a tile grid suitable to the subpictures can be formed. The benefit would be additional compression gain thanks to motion vectors over subpicture boundaries being saturated.

It is to be understood that instead of a frame packing arrangement SEI message, embodiments may be realized with a dedicated other SEI message that indicates temporal interleaving of content frames or non-ROIs and frames comprising ROIs.

It is to be understood that embodiments may be similarly realized with frame 0 containing ROI(s) of frame 1. In an embodiment, it is indicated in the frame packing arrangement SEI message or any other SEI message when frame 0 comprises ROI(s) of frame 1, which represents a content frame or non-ROIs, or, alternatively, if frame 1 comprises ROI(s) of frame 0, which represents a content frame or non-ROIs.

In an embodiment, it is indicated in the frame packing arrangement SEI message or any other SEI message whether the frame not comprising ROI(s) comprises a content frame or non-ROIs. For example, fp_content_interpretation_type equal to a first value (e.g., value 3) may indicate that frame 0 comprises ROI(s) and frame 1 comprises non-ROI(s) (and does not comprise ROIs), and fp_content_interpretation_type equal to a second value (e.g., value 4) may indicate that frame 0 comprises ROI(s) and frame 1 comprises a content frame.

In an embodiment, a decoder:
decodes, from a frame packing arrangement SEI message, that temporal interleaving of alternating first and second constituent frames is in use; and
decodes, from the frame packing arrangement SEI message, a content interpretation type indicating that every other frame comprises only ROI(s) and every other frame comprises a content frame or non-ROI(s).

In an embodiment, a decoder infers that a frame contains only ROI(s), when its scaling window (as defined in VVC) is larger than the picture boundaries.

In an embodiment, a decoder infers that a frame comprises a content frame when its scaling window (as defined in VVC) is smaller than the picture boundaries.

In an embodiment, an encoder indicates, e.g., in an SEI message, that when the scaling window of a picture is larger than the picture boundaries, the picture includes ROIs only. Likewise, a decoder decodes, e.g., from an SEI message, that when the scaling window of a picture is larger than the picture boundaries, the picture includes ROIs only.

In an embodiment, an encoder indicates, e.g., in an SEI message, that when the scaling window of a picture is smaller than the picture boundaries, the picture comprises a content frame. Likewise, a decoder decodes, e.g., from an SEI message, that when the scaling window of a picture is smaller than the picture boundaries, the picture comprises a content frame.

In an embodiment, an encoder may indicate to a decoder or receiver, for example, at the beginning of a coded layer video sequence, which frames comprise only ROIs. In one example, the encoder indicates that the frames with temporal sublayer identifiers greater than or equal to a signaled value comprise only ROIs. In another example, the encoder indicates that frames in the first GOP of every N GOPs comprise only ROIs, where a GOP is indicated or inferred. In yet another example, a picture order count (POC) based rule is pre-defined or indicated. For example, it may be indicated that pictures with an odd POC value comprise only ROIs. In yet another example, the encoder indicates that the frames encoded based on a certain range of QPs comprise only ROIs. The QP may for example be the initial QP of the first slice of the frame. For example, the value of SliceQp_{Y} of the first slice of a picture in VVC may be used for determining if the frame comprises only ROIs. For example, an encoder may indicate that frames encoded based on a QP lower than 25 comprise only ROIs. In yet another example, the encoder indicates that the frames containing objects or regions bigger than a certain size comprise only ROIs, or comprise both non-ROIs and ROIs, where ROIs are represented with higher resolutions and/or fidelity than the corresponding ROIs in the content frame. For example, an encoder may indicate the certain size as a width and a height (e.g., in terms of chroma samples), or as a number of samples (e.g., the number of samples in a single chroma sample array). For this example, the decoder or receiver may then need to run an object detector or a region-proposal detector on a decoded frame in order to infer whether that frame comprises only ROIs.

In an embodiment, an encoder may indicate to a decoder or receiver, for example at the beginning of a coded layer video sequence, which frames are content frames. In an example, the encoder indicates that the frames with temporal sublayer identifiers less than or equal to a signaled value are content frames. In another example, the encoder indicates that frames in a first GOP of every N GOPs are content frames, where a GOP is indicated or inferred. In yet another example, a picture order count (POC) based rule is pre-defined or indicated. For example, it may be indicated that every N-th frame in POC order is a content frame. In another example, the POC values of the content frame may be indicated for a random access segment, for example, relative to the POC value of the first frame of the random access segment, where a random access segment may be defined as a sequence of pictures from a random access point (RAP) picture, inclusive, to the next RAP picture, exclusive, in decoding order.

In an embodiment, the constituent frame sequence of content frames may be indicated to be coherent or suitable for watching or user viewing. In an embodiment, the absence of signaling that the constituent frame sequence of content frames may be suboptimal for user viewing is interpreted as an indication that the constituent frame sequence of content frames is coherent or suitable for watching or user viewing. In an example, the suboptimal user viewing indication SEI message or a machine consumption indication SEI message may indicate that the video resulting by decoding the current CLVS is not optimized for user viewing and may therefore look incoherent for user viewing. In another example, a syntax element, such as a flag, in video usability information (VUI), which may be called vui_non_machine_consumption_flag, indicate that there are no machine consumption indication SEI messages or alike present in the CLVS.

In an embodiment, the constituent frame sequence of ROIs may be indicated to be suboptimal or unsuitable for watching or user viewing by including a suboptimal user viewing indication SEI message or a machine consumption indication SEI message into a regional nesting SEI message, which defines region(s) enclosing the constituent frame comprising ROIs.

### Inter Prediction in Temporal Interleaving

Prediction from a second constituent frame to a first constituent frame of the same timestamp or vice versa can be enabled through reference picture resampling, as defined in VVC. Reference picture resampling uses scaling windows which can be used, for example, for locating the first constituent frame within the area of the second constituent frame.

In an embodiment, a scaling window, as defined in VVC, is encoded for each frame in the bitstream and the scaling window matches with the content frame boundaries within each frame. An example of this embodiment is described in FIG. 9.

FIG. 9. illustrates an example usage of scaling windows for indicating spatial correspondence for inter prediction in temporal interleaving, in accordance with an embodiment. The scaling window may cover the small-resolution content frame in a frame with timestamp to and TID equal to 0 and the content frame that may contain the high-resolution bus in a frame with timestamp to and TID equal to 1. Consequently, the picture with TID equal to 1 is then predicted from respective small-resolution areas in picture with TID equal to 0.

Fusing the First Constituent Frame Sequence and the Second Constituent Frame Sequence into a Composed Video Sequence

In an embodiment, the first constituent frame sequence (comprising ROIs only) is associated with a subset of the timestamps compared to those of the second constituent frame sequence (comprising content frames). The frame rate of the first constituent frame sequence is upsampled as postprocessing of the decoder. A neural network may perform the frame rate upsampling. Embodiments are presented below on the frame rate upsampling.

It is to be understood that even if examples are described with temporal interleaving of constituent frames, examples could similarly be realized with spatial packing or multi-layer coding.

In an embodiment, for each timestamp where a second constituent frame does not have the corresponding first constituent frame, the decoder or receiver may identify ROIs to be generated, initialize the composed frame to be an upsampled content frame carried in the second constituent frame, and perform the following for each ROI to be generated:
Frame rate upsampling as discussed below may be applied to create a generated ROI.
The composed frame may be updated by overlaying the generated ROI on top of composed frame.

The method for a decoder to identify a missing constituent frame including ROIs (e.g., a missing first constituent frame) to be generated may include, but may not be limited to, one or more of the following:
The decoder decodes or infers that packing of constituent frames has been applied in the bitstream.
The decoder decodes or infers which type of packing of constituent frames has been applied in the bitstream.
The decoder decodes or infers which frames and/or regions comprise constituent frame(s) including ROI(s) and which frames and/or regions comprise non-ROIs or background. For example, the decoder decodes, e.g., from an SEI message, that when the scaling window of a picture is larger than the picture boundaries, the picture contains ROIs only. In another example, a decoder decodes a content interpretation type that indicates which constituent frames comprise content frame(s) and which constituent frames comprise ROI(s).
The decoder decodes or infers which constituent frames form constituent frame pairs (of the same time instance).
The decoder identifies an unpaired constituent frame pair that contains only the constituent frame that includes non-ROIs or background.

The method for a decoder to identify ROI(s) within a missing constituent frame to be generated may include, but may not be limited to, one or more of the following:
The decoder decodes an annotated regions SEI message for the time-aligned content frame. ROIs that are indicated by the annotated regions SEI message are to be generated.
The decoder decodes annotated regions SEI message(s) for content frame(s) or constituent frame(s) comprising ROIs that time-wise adjacent to the missing constituent frame. ROIs that are indicated by the annotated regions SEI message(s) are to be generated.
The decoder detects ROIs from the time-aligned content frame using any ROI detection method. The detected ROIs are to be generated.
The decoder detects ROIs from content frame(s) or constituent frame(s) comprising ROIs that time-wise adjacent to the missing constituent frame. The detected ROIs are to be generated.

Embodiments are described in relation to frame rate upsampling NNPF taking two or more input frames and assisted by coinciding frame(s) that are time-aligned with the interpolated frame(s) generated by the frame rate upsampling. It is to be understood that embodiments may similarly be understood to relate to visual quality enhancement NNPF of the coinciding frame(s) on the basis of the two or more input frames. The coinciding frame(s) are given as input to the NNPF together with the two or more input frames. When embodiments are realized with a visual quality enhancement NNPF, the input pictures coinciding with the interpolated pictures may be understood to be pictures that are indicated to be output by the NNPF. For example, nnpfc_input_pic_output_flag[i] equal to 1 indicates that for the i-th input picture the NNPF generates a corresponding output picture whereas nnpfc_input_pic_output_flag[i] equal to 0 indicates that for the i-th input picture the NNPF does not generate a corresponding output picture.

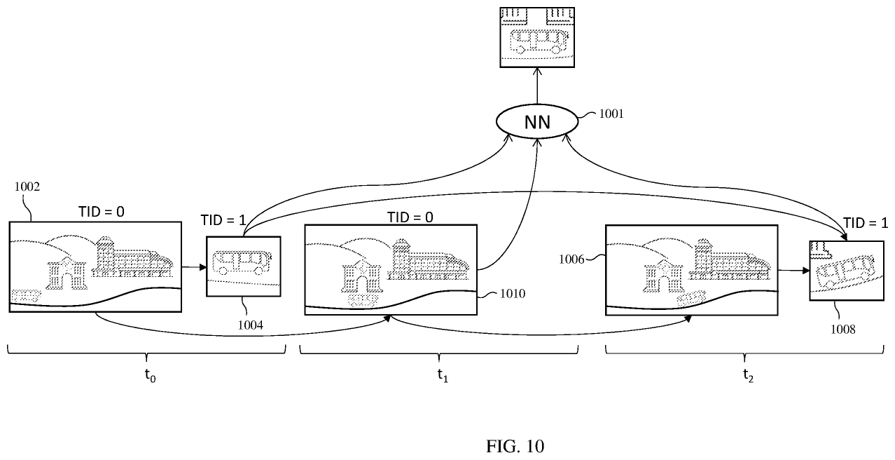

In an embodiment, a neural network gets as input the time-aligned content frame and the time-wise adjacent constituent frames comprising only ROIs, and may also get the time-wise adjacent content frames as input. The NN creates a constituent frame comprising ROI(s) that corresponds to the time-aligned content frame. An example of this embodiment is described in FIG. 10.

FIG. 10 illustrates an upsampling frame rate of ROI constituent frames assisted by a time-aligned content frame, in accordance with an embodiment. For timestamp t1, a constituent frame that includes only a ROI is not encoded but is created through NN inference 1001 in the decoder side. The constituent frames 1002, 1004, 1006, and 1008 at timestamps t0 and t2 including respective ROIs are given as input to the neural network inference, together with a content frame 1010 of timestamp t1.

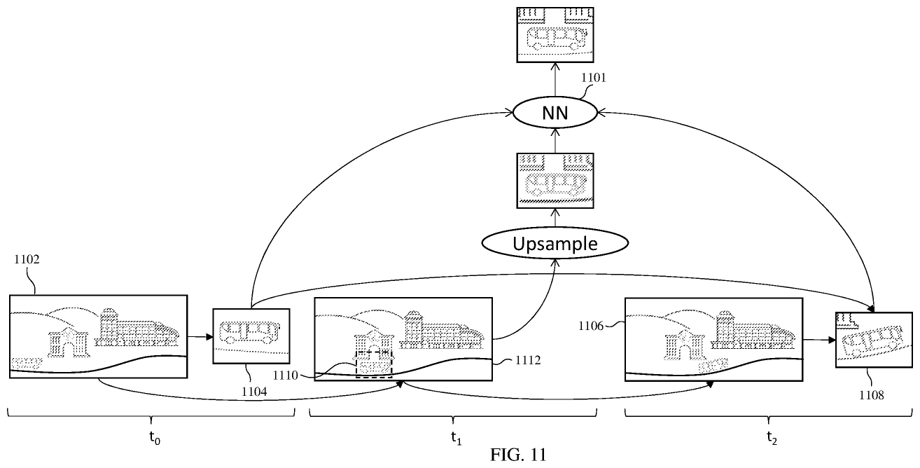

In an embodiment, a neural network gets as input the ROI bounding box region from the time-aligned content frame and the time-wise adjacent constituent frames comprising only ROIs. The ROI bounding box region may be upsampled to have the same width and height as in the constituent frames. The NN creates a ROI that corresponds to the time-aligned content frame. An example of this embodiment is described in FIG. 11.

FIG. 11 illustrates an upsampling frame rate of ROI constituent frames assisted by an ROI extracted from a time-aligned content frame, in accordance with an embodiment. For timestamp t1, a constituent frame that contains only a ROI is not encoded but is created through NN inference 1101 in the decoder side. The constituent frames 1102, 1104, 1106, and 1108 at timestamps t0 and t2 including respective ROIs are given as input to the NN inference 1101, together with the ROI bounding box region 1110 of the content frame 1112 of timestamp t1. In this example, the ROI bounding box region 1110 is upsampled prior to providing it as input to the NN inference 1101. However, it is to be understood that the example may likewise be realized without upsampling the ROI bounding box region 1110 of the content frame and providing it as such, as an input to the NN inference 1101.

In an embodiment, the NN may also get information about the timestamps of the input frames as an input. In one example, the input frames have timestamps t0, t1, t2, t3, where t2 corresponds to only a content frame, and the NN is to generate an ROI frame for timestamp t2. Each input frame may be concatenated with a matrix whose elements have a value that represents the timestamp of that input frame.

In an embodiment, the NN may also get information about the output order of the input frames as an input. For example, a second input frame that follows a first input frame in output order may have a greater output order value. Input frames that have the same timestamp may have the same output order value. Each input frame may be concatenated with a matrix whose elements have the output order value of that input frame.

When the NN inference generates ROI(s), the fusing may comprise the following ROI overlaying as post-processing of decoding: the content frame that is time-aligned with the generated ROI(s) may be upsampled to match the resolution of generated ROI(s), and each generated ROI is overlaid on top of the time-aligned upsampled content frame.

As a part of ROI overlaying, blending may be applied at the edges of the constituent frames comprising ROI(s) so that the constituent frame edges would not cause false detections in the task network.

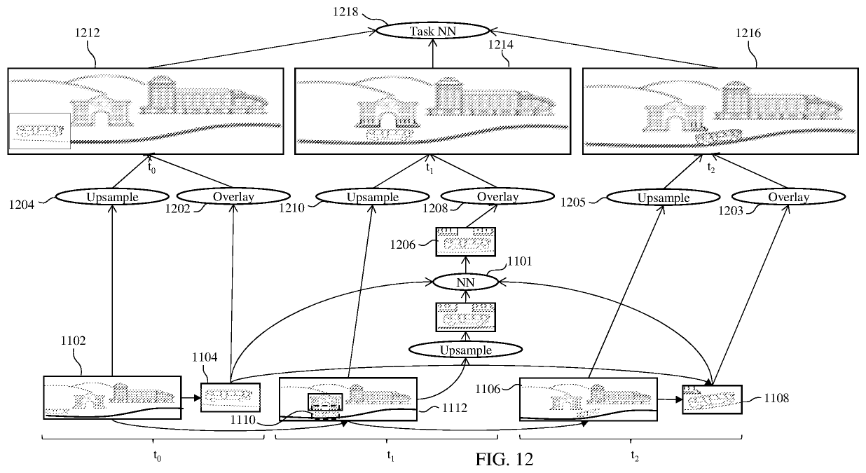

FIG. 12 illustrates an example of ROI overlaying and usage of ROI-overlaid upsampled content frames as input to task NN, in accordance with an embodiment. FIG. 12 extends the example given in FIG. 11. For timestamps t0 and t2, the constituent frames 1104 and 1108 comprising only an ROI are overlaid 1202, 1203 on top of upsampled 1204, 1205 content frame. For timestamp t1, the ROI 1206 generated by the NN 1101 post-filter is overlaid 1208 on top of the respective upsampled 1210 content frame. The ROI-overlaid upsampled content frames 1212, 1214, and 1216 are used as input to a task NN 1218.

In an embodiment, for each timestamp where a second constituent frame does not have the corresponding first constituent frame, the decoder may identify ROIs to be generated, initialize the composed frame to be an upsampled content frame carried in the second constituent frame, and perform the following for each ROI to be generated:
Frame rate upsampling as discussed below may be applied to update a composed frame.

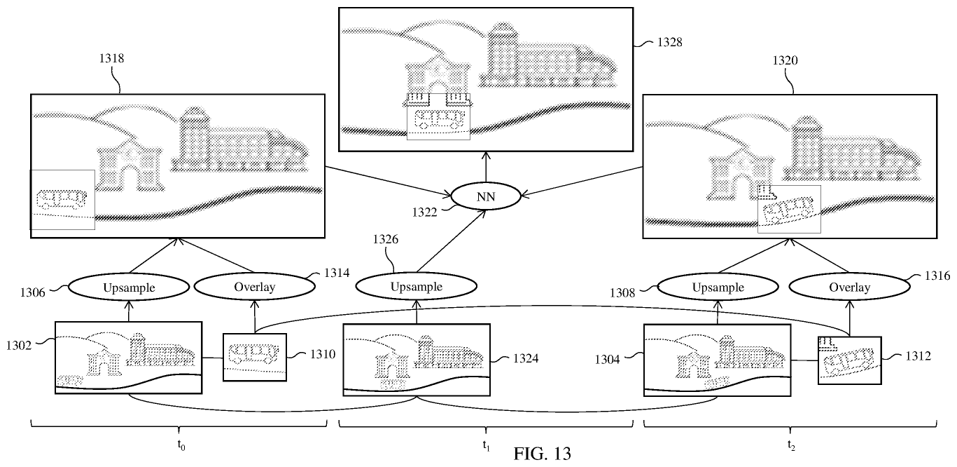

In an embodiment, for each time-wise adjacent pair of constituent frames, the content frame may be upsampled to match the resolution of ROI(s), and each ROI is overlaid on top of the upsampled content frame. The time-aligned content frame may be upsampled to match the resolution of ROI(s). The time-wise adjacent, ROI-overlaid, upsampled content frames and the time-aligned upsampled content frame are input to a neural network. As output, the NN enhances the ROI in the time-aligned content frame. An example of this embodiment is described in FIG. 13.

FIG. 13 illustrates upsampling frame rate of ROI-overlaid frames assisted by a time-aligned content frame, in accordance with an embodiment. For timestamp t1, a constituent frame that includes only a ROI has not been encoded. The constituent frames comprising content frames 1302, 1304 at timestamps t0 and t2 are upsampled 1306, 1308, and the respective constituent frames containing a ROI 1310, 1312 are overlaid 1314, 1316 on top of the upsampled content frames. The resulting ROI-overlaid upsampled content frames 1318, 1320 are provided as input to the NN inference 1322. The content frame 1324 of timestamp t1 is upsampled 1326 and then given as input to the NN inference 1322. The NN inference 1322 generates an enhanced content frame 1328 at timestamp t1 wherein the ROI has been enhanced compared to that in the content frame 1324 at timestamp t1.

In various embodiments, the ROI bounding box in the time-aligned content frame may also be given as input to the NN. The ROI bounding box may, for example, be obtained from an annotated regions SEI message associated with the constituent frame comprising the content frame.

It is to be understood that the described embodiments may be applied to the case where the second constituent frame sequence (comprising content frames) has a subset of the timestamps compared to those of the first constituent frame sequence (comprising ROIs only). The frame rate of the second constituent frame sequence is upsampled as postprocessing of the decoder. A neural network may perform the frame rate upsampling. The neural network may take as input the time-aligned constituent frames comprising only ROIs, the time-wise adjacent content frames, and may also get the time-wise adjacent constituent frames comprising only ROIs frames as input.

### Encoder-Side Decisions

In an embodiment, there may be an encoder configuration or a heuristic rule to select a first set of timestamps that are coded into a first constituent frame sequence comprising only ROIs. Likewise, there may be an encoder configuration or heuristic rule to select a second set of timestamps in a second constituent frame sequence comprising content frames or non-ROIs. For example, the encoder may be configured to halve the frame rate for the first constituent frame sequence compared to the frame rate of the second constituent frame sequence.

In an embodiment, an encoder estimates or derives a machine analysis precision of a composed video sequence resulting from fusing the first constituent frame sequence and the second constituent frame sequence, for different sets of timestamps selected to be included in the first constituent frame sequence and the second constituent frame sequence. For example, the encoder may determine for every other first constituent frame (comprising only ROIs) whether to encode it based on the estimated or derived machine analysis precision. The encoder may perform rate-distortion-based selection of timestamps selected to be included in the first constituent frame sequence and the second constituent frame sequence, where the distortion may be the estimated or derived machine analysis precision of a composed video sequence resulting from fusing the first constituent frame sequence and the second constituent frame sequence.

### Indication of Regional Post-Processing Filtering

A regional nesting SEI message includes one or more nested SEI messages that apply to indicated regions. In an embodiment, the regional nesting SEI message indicates object regions as defined by the annotated regions SEI message. For example, regional_nesting_num_rect_regions equal to 0 specifies that the regional nesting SEI message concerns one or more regions specified by the annotated regions SEI message. When regional_nesting_num_rect_regions is equal to 0, regional_nesting_sei_region_idx[i][j] specifies the value of ar_object_idx[k] of the j-th region to which the i-th region-nested SEI message in the regional nesting SEI message is associated.

### Indication of Input Pictures

In an embodiment, a source of the input pictures coinciding with the interpolated pictures generated by the post-processing filter is inferred, for example, according to, but not necessarily limited to, one or more of the following conditions:
When the post-processing filter is activated for a dependent layer, the input pictures coinciding with the interpolated pictures generated by the post-processing filter originate from the reference layer of the dependent layer that has the highest layer identifier.
When the post-processing filter is activated for a picture that includes a first constituent frame in temporal interleaving frame packing arrangement, the input pictures coinciding with the interpolated pictures generated by the post-processing filter originate from pictures including the second constituent frame in temporal interleaving frame packing arrangement.
When the post-processing filter is activated for a picture that includes a second constituent frame in temporal interleaving frame packing arrangement, the input pictures coinciding with the interpolated pictures generated by the post-processing filter originate from pictures including the first constituent frame in temporal interleaving frame packing arrangement.
When spatial packing is in use, and a constituent frame outside of the scaling window is defined to be in the scope of the NNPFC SEI message, and a picture coinciding with the interpolated picture has no constituent frame outside of the scaling window, the input picture is the constituent frame within the scaling window in the picture.

In an embodiment, an NNPFC SEI message or an NNPFA SEI message or alike may be appended with an indication of a source of the input pictures coinciding with the interpolated pictures generated by the post-processing filter, wherein the set of possible sources may comprise one or more of the following:
Information indicative of a scalability layer, such as a layer identifier or a layer index, that is the source of the input picture(s).
A reference layer of the current scalability layer where the post-processing filter defined by the NNPFC SEI message is active. The reference layer may be inferred to be the reference layer that has the highest layer identifier, or the layer identifier of the reference layer may be indicated.
When temporal interleaving is indicated, e.g., by a frame packing arrangement SEI message, the source may be the opposite constituent frame of the constituent frame pair that also comprises the constituent frame to which the post-processing filter defined by the NNPFC SEI message is active.
When spatial packing is in use, and a constituent frame outside of the scaling window are defined to be in the scope of the NNPFC SEI message, and a picture coinciding with the interpolated picture has no constituent frame outside of the scaling window, the source may be the constituent frame within the scaling window in the picture.

In an embodiment, an NNPFC SEI message or an NNPFA SEI message or alike may comprise an indication of a source of the input pictures, wherein the source may comprise for any input picture one or more of the following:
Syntax element(s) indicative of the scalability layer of the input picture. For example, value 0 may indicate the current layer (wherein the SEI message resides), value 1 may indicate its first reference layer, when any, value 2 may indicate its second reference layer, when any, and so on. In another example, the layer identifier (e.g. nuh_layer_id according to some video coding standards) may be used.
When temporal interleaving is indicated, the parity of the constituent frame (e.g., constituent frame 0 or constituent frame 1).
Region within a cropped decoded picture to be regarded as input picture.

In an embodiment, an NNPFC SEI message or an NNPFA SEI message or alike may additionally be indicative of the temporal position or order of input pictures for the post-filter. For example, the NNPFA SEI message may comprise a differential POC value for each input picture beyond the picture unit that includes the NNPFA SEI message. The input pictures may be indicated in decreasing POC value order. The first differential POC value may be the difference between the POC value the first indicated picture and the POC value of the picture unit including NNPFA SEI message, the second differential POC value, when any, may be the difference between the POC value of the second indicated picture and the POC value of the third indicated picture, the third differential POC value, when any, may be the difference between the POC value of the third indicated picture and the POC value of the fourth indicated picture, and so on.

In an embodiment, when a source of the input pictures coinciding with the interpolated pictures generated by the post-processing filter has a different spatial resolution than the input pictures not coinciding with the interpolated pictures, spatial upsampling of the source is performed to obtain the same spatial resolution in all input pictures. The spatial upsampling may be performed by a neural-network post-filter. The neural-network post-filter for spatial upsampling may be defined by NNPFC SEI message(s) and may be activated by NNPFA SEI message(s).

In an embodiment, width and height in samples are provided separately for each input picture for neural-network post-filtering.

In an embodiment, width and height in samples are provided for the group of input pictures coinciding with the interpolated pictures generated by the post-processing filter separately from the group of input pictures not coinciding with the interpolated pictures generated by the post-processing filter.

### Example SEI Message Usage

In an example, an encoder generates the following SEI messages in relation to the example of FIG. 11:
NNPFC SEI message(s) that define a frame rate upsampling filter, which takes two adjacent frames as input, generates one interpolated between the adjacent frames, and also takes one frame coinciding with the interpolated frame as input.
NNPFC SEI message(s) that define a spatial upsampling filter.
In the picture unit including the constituent, frame at t1, that includes a content frame:
   Regional nesting SEI message, where the region encloses the ROI within the content frame and the nested SEI message is an NNPFA SEI message activating the spatial upsampling filter.
In the picture unit including the constituent frame, at t2, that includes only an ROI:
   An NNPFA SEI message activating the frame rate upsampling filter.

As the frame rate upsampling filter is activated for constituent frame 1 of temporal frame packing arrangement, the previous constituent frame 1 (at t0) is used as input, and the coinciding frame is the constituent frame 0 at t1 and the output order of frame 0 is between timestamps t0 and t2. As the constituent frame 0 at t1, has different spatial resolution than the constituent frames 1 used as adjacent pictures for the frame rate upsampling filter, the spatial upsampling filter activated for the defined region of the constituent frame 0 at t1 is performed prior to using the spatially upsampled region as the coinciding frame for the frame rate upsampling filter.

### First Constituent Frame Sequence Comprising Both ROIs and Non-ROIs

In an embodiment, the first constituent frames comprise both foreground (.e.g., ROIs) and background (e.g., non-ROIs), but the reconstructed background may have low visual quality and may be unpleasant for user viewing. The first constituent frame sequence may be intended to be used as input to machine vision task(s) as such or when fused with the second constituent frame sequence. The second constituent frames comprise content frames that may be suitable for user viewing but may have low resolution.

In an embodiment, an NN post-filter takes one or more of the following as input:
a first constituent frame;
a second constituent frame that is time-aligned with the first constituent frame; or
information indicative of the regions of the first constituent frame to be filtered with guidance or supervision from the second constituent frame.

The NN post-filter enhances the indicated regions of the first constituent frame based on the respective regions of the second constituent frame.

In an embodiment, an encoder defines in or along the bitstream an NN post-filter that enhances the indicated regions of a first constituent frame based on the respective regions of a second constituent frame and takes one or more of the following as input:
the first constituent frame;
the second constituent frame that is time-aligned with the first constituent frame; or
information indicative of the regions of the first constituent frame to be filtered with guidance or supervision from the second constituent frame.

Furthermore, an encoder indicates in or along the bitstream which pairs of first and second constituent frames this NN post-filter may be used or may be activated.

In an embodiment, the NNPFC SEI message or the NNPFA SEI message or alike includes a flag (e.g., a nnpfc_aligned_pic_flag) that may be present for any filtering purpose. The flag, e.g. when equal to 1, may indicate when the post-filter takes as input a picture to be filtered as well as a coinciding picture(s). The coinciding input picture(s) may be indicated or inferred to be one of the following:
When the post-processing filter is activated for a dependent layer, the coinciding input picture(s) originate from the reference layer(s) of the dependent layer. For example, a single coinciding input picture may be inferred to originate from the reference layer that has the highest layer identifier.
When the post-processing filter is activated for a first scalability layer, the coinciding input picture(s) originate from a second scalability layer, which may be indicated in the NNPFC SEI message or the NNPFA SEI message or alike. The second scalability layer may be, but is not necessarily, a reference layer of the first scalability layer. For example, both the first and second scalability layers may both be independent layers.
When the post-processing filter is activated for a first constituent frame of frame packing arrangement, the coinciding input picture may be the other constituent frame complementing the first constituent frame.

In an embodiment, the NNPFC SEI message or the NNPFA message or alike includes a flag (e.g., a nnpfc_aligned_pic_flag[i]) per each input picture, regardless of the filtering purpose. The flag, e.g., when equal to 1, may indicate that the input picture is a coinciding input picture. The flag, e.g., when equal to 0, may indicate that the input picture is selected as presently according to the NNPFC and NNPFA SEI messages. The coinciding input picture(s) may be indicated or inferred to be one of the following:
When the post-processing filter is activated for a dependent layer, the coinciding input picture(s) originate from the reference layer(s) of the dependent layer. For example, a single coinciding input picture may be inferred to originate from the reference layer that has the highest layer identifier.
When the post-processing filter is activated for a first scalability layer, the coinciding input picture(s) originate from a second scalability layer, which may be indicated in the NNPFC SEI message or the NNPFA SEI message or alike. The second scalability layer may be, but is not necessarily, a reference layer of the first scalability layer. For example, both the first and second scalability layers may both be independent layers.
When the post-processing filter is activated for a first constituent frame of frame packing arrangement, the coinciding input picture may be the other constituent frame complementing the first constituent frame.

In an embodiment, an NNPFA SEI message includes information indicative which of the output pictures are suggested to be processed further, e.g., by subsequent filtering in cascade or by displaying. The information may comprise, for example, a bit field where each bit corresponds to an output picture and the length (in bits) of the bit field is equal to the number of output pictures in the output tensor. In an embodiment, an encoder indicates an output picture not to be processed further, when the NNPF generates the output picture, but it is not needed for further processing.

In an embodiment, information indicative of the regions of the first constituent frame to be filtered with guidance or supervision from the second constituent frame may be indicated by including an NNPFA SEI message within a regional nesting SEI message.

In one embodiment, the postfilter receives the frame to be filtered and semantic information as input. Semantic information may comprise data describing one or more semantic features of the input frame and/or of other frames. Examples of semantic features may include, but may not be limited to, the following:
Position and size information of one or more regions present in the input image that are to be treated specifically by the postfilter. For example, bounding box(es), which may, for instance, be represented as two position coordinates, a vertical size and a horizontal size;
Position and size information of one or more objects present in the input image. For example, bounding box(es), which may, for instance, be represented as two position coordinates, a vertical size and a horizontal size;
Contour or silhouette or shape of one or more objects present in the input image. For example, a binary mask, e.g., a matrix with same height and width as the input image and whose elements can take one of two predetermined values, where one value indicates the presence of an object in the input image at the corresponding position and where another value indicates the absence of an object in the input image at the corresponding position;
Information about the class or category to which an object belongs. For example, a class index for each pixel, or for each bounding box;
Textual object label. Additionally, a language of the object label may be indicated or pre-defined;
Instance identity, which identifies a specific object. For example, an index for each pixel, or for each bounding box, where the values of the index associated to the pixels of the same object take the same value;
Confidence, which may be associated with the semantic information in general and/or any individual piece of semantic information, such as confidence of an object class. Confidence may have a certain range, such as from 0.0 to 1.0, inclusive, where 0.0 indicates the lowest confidence and 1.0 indicates the highest confidence. The confidence may be informative of how confident or how reliable associated semantic information is; and/or
Saliency or importance, which may be associated with the semantic information in general and/or any individual piece of the semantic information, such as the saliency score of an object class.
Depth, distance, or distance, which may, for example, comprise a monochrome sample array, where each sample value is indicative of the depth, distance, or disparity of the respective sample location in a color sample array.

Semantic information may additionally comprise or be accompanied by data describing a coded representation of the input frame and/or of other frames. Examples of such data may include, but may not be limited to, the following:
Spatial partitioning of the input frame to image segments, such as subpictures, slices, and/or tiles;
Quantization Parameter (QP), at one or more levels of partitioning the bitstream, such as a sequence-level QP, a picture-level QP, and/or slice-level QP;
Slice type, e.g., one of the following: I, P, or B, where:
   i. an I slice may be defined as a slice that is decoded using intra prediction only,
   ii. a P slice may be defined as a slice that is decoded using intra prediction or using inter prediction with at most one motion vector and reference index to predict the sample values of each block, and
   iii. a B slice may be defined as a slice that is decoded using intra prediction or using inter prediction with at most two motion vectors and reference indices to predict the sample values of each block;
Information about the temporal layer in a temporal prediction hierarchy.
Chroma sampling location relative to the luma sampling location, when a chroma sample array is subsampled compared to a luma sample array, e.g., in the case of 4:2:0 chroma format.
Information on the sample value range, such as a flag indicating, when equal to a pre-defined value, such as 1, that the full range has been used in the input frame, or when equal to another pre-defined value, such as 0, that a so-called studio range has been used been used in the input frame.

In an embodiment, different features of the semantic information may be combined into one or more channels of an input tensor used as input to a neural-network postfilter. The one or more channels may be referred to as additional channels, or auxiliary channels. For example, an auxiliary channel may comprise a two-dimensional array with dimensions equal to the width and height of the luma sample array where each array element in the auxiliary channel is a real value, where the integer part represents an instance identity (where 0 may represent no instance identity) of the respective luma sample location and the decimal part represents a confidence of the respective luma sample being mapped to the instance. In another example, a channel may comprise a two-dimensional array with dimensions equal to the width and height of the luma sample array where each array element is a real value, where the integer part represents a class index of the respective luma sample location and the decimal part represents a confidence of the respective luma sample being mapped to the class index. In another example, a channel may comprise a two-dimensional array with dimensions equal to the width and height of the luma sample array where each element in the auxiliary channel is the product of the confidence score and the saliency score of the corresponding location of the element.

In an embodiment, an SEI message, such as an NNPFA SEI message, activating a particular post-filter may be used to carry the semantic information for filtering the pictures for which the post-filter is activated by the SEI message.

In an embodiment, an SEI message, such as an NNPFA SEI message or a regional neural-network post-filter activation SEI message, activating a particular post-filter may be used to carry regions of interest for filtering the pictures for which the post-filter is activated by the SEI message.

It is to be understood that embodiments described in relation to regional nesting SEI message comprising an NNPFA SEI message may similarly be realized with an NNPFA SEI message comprising semantic information about regions or a regional neural-network post-filter activation SEI message.

In an embodiment, different features of the semantic information may be generated by an NNPF and included into one or more channels of an output tensor. The one or more channels may be referred to as additional channels, or auxiliary channels. Examples provided above for auxiliary channels in an input tensor apply similarly to channels of an output tensor.

In an example embodiment, an NNPF inputs multiple pictures, and for some of the pictures it inputs semantic information, such as bounding box(es) of ROIs. The NNPF generates bounding box(es) of respective ROIs as auxiliary channel(s) in the output tensor for one or more of the input pictures for which the bounding box(es) were not given as input. The respective ROIs may, for example, be defined to enclose the same tracked objects as enclosed by the bounding box(es) given as input to the NNPF.

In another example embodiment, an NNPF inputs multiple pictures from different views of multiview content, such as from two views of a stereoscopic camera. The pictures of different views may reside in different scalability layers or in different constituent pictures of a frame packing arrangement. An NNPFA SEI message or alike may indicate the scalability layers for which the NNPF is activated, or the regions comprising the constituent pictures for which the NNPF is activated. The NNPF generates a sample array indicating depth, distance, or disparity as an auxiliary channel in the output tensor.

In various embodiments, the terms ‘picture’, ‘image’, and ‘frame’ may be used interchangeably.

In various embodiments, the terms ‘machine vision’, ‘machine vision task’, ‘machine task’, ‘machine analysis’, ‘machine analysis task’, ‘computer vision’, ‘computer vision task’, ‘task network’ and ‘task’ may be used interchangeably.

In various embodiments, the terms ‘machine consumption’ and ‘machine analysis’ may be used interchangeably.

In various embodiments, the terms ‘machine-consumable’ and ‘machine-targeted’ may be used interchangeably.

In various embodiments, the terms ‘user viewing’, ‘human observation’, ‘human perception’, ‘displaying’, ‘displaying to human beings’, ‘watching’, and ‘watching by human beings’ may be used interchangeably.

In various embodiments, the term ‘subjective’ may imply ‘human perception’.

In various embodiments, the terms ‘inconsistent’ and ‘incoherent’ may be used interchangeably.

In various embodiments, the terms ‘post-filter’, ‘post-processing filter’ and ‘postprocessing filter’ may be used interchangeably.

In various embodiments, the terms ‘non-ROIs’, ‘background’ and ‘background region’ may be used interchangeably.

In various embodiments, the terms ‘ROIs’, ‘foreground’ and ‘foreground region’ may be used interchangeably.

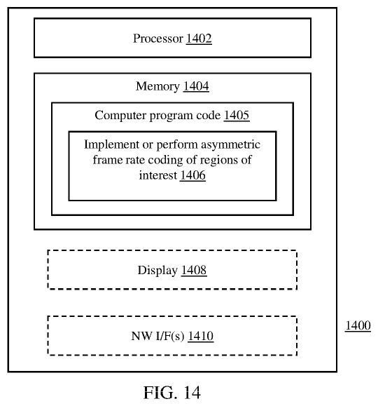

FIG. 14 is an example apparatus 1400, which may be implemented in hardware, caused to implement asymmetric frame rate coding of regions of interest, based on the examples described herein. The apparatus 1400 comprises at least one processor 1402, at least one non-transitory memory 1404 including computer program code 1405, wherein the at least one memory 1404 and the computer program code 1405 are configured to, with the at least one processor 1402, cause the apparatus 1400 to perform asymmetric frame rate coding of regions of interest 1406, based on the examples described herein.

The apparatus 1400 optionally includes a display 1408 that may be used to display content during rendering. The apparatus 1400 optionally includes one or more network (NW) interfaces (I/F(s)) 1410. The NW I/F(s) 1410 may be wired and/or wireless and communicate over the Internet/other network(s) via any communication technique. The NW I/F(s) 1410 may comprise one or more transmitters and one or more receivers. The N/W I/F(s) 1410 may comprise standard well-known components such as an amplifier, filter, frequency-converter, (de) modulator, and encoder/decoder circuitry(ies) and one or more antennas.

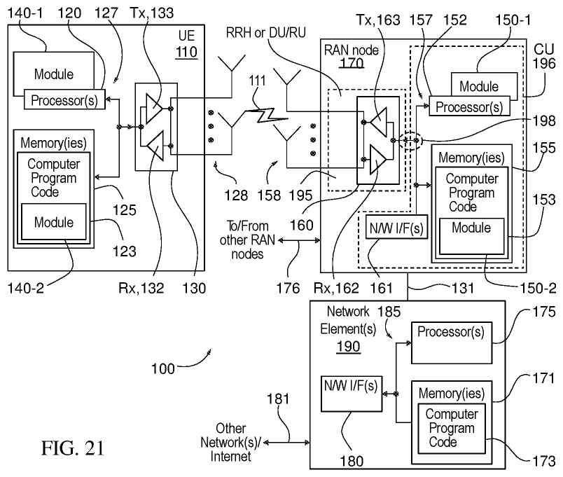

The apparatus 1400 may be a remote, virtual or cloud apparatus. The apparatus 1400 may be either a coder or a decoder, or both a coder and a decoder. The at least one memory 1404 may be implemented using any suitable data storage technology, such as semiconductor based memory devices, flash memory, magnetic memory devices and systems, optical memory devices and systems, fixed memory and removable memory. The at least one memory 1404 may comprise a database for storing data. The apparatus 1400 need not comprise each of the features mentioned, or may comprise other features as well. The apparatus 1400 may correspond to or be another embodiment of the apparatus 50 shown in FIG. 1 and FIG. 2, any of the apparatuses shown in FIG. 3, or apparatus 1400 of FIG. 14. The apparatus 1400 may correspond to or be another embodiment of the apparatuses shown in FIG. 21, including UE 110, RAN node 170, or network element(s) 190.

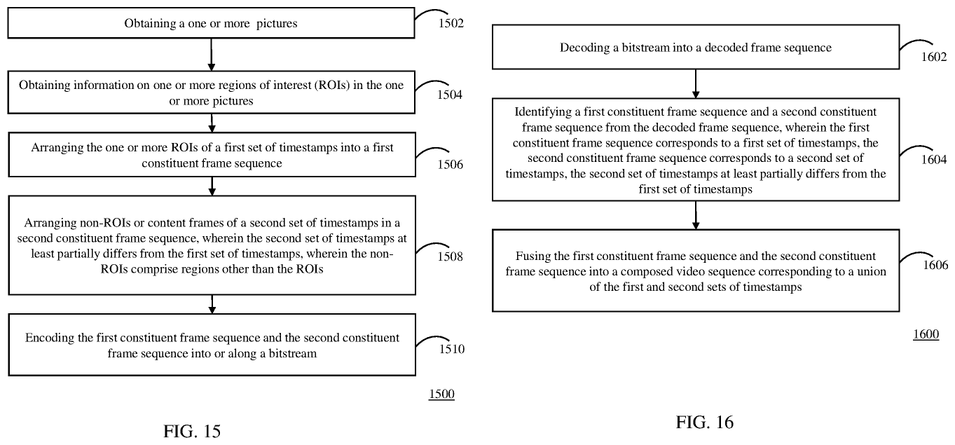

FIG. 15 is an example method 1500 to implement the examples described herein, in accordance with an embodiment. At 1502, the method 1500 includes obtaining a one or more pictures. At 1504, the method 1500 includes obtaining information on one or more regions of interest (ROIs) in the one or more pictures. At 1506, the method 1500 includes arranging the one or more ROIs of a first set of timestamps into a first constituent frame sequence. At 1508, the method 1500 includes arranging non-ROIs or content frames of a second set of timestamps in a second constituent frame sequence, wherein the second set of timestamps at least partially differs from the first set of timestamps, wherein the non-ROIs comprise regions other than the ROIs. At 1510, the method 1500 includes encoding the first constituent frame sequence and the second constituent frame sequence into or along a bitstream.

In an embodiment, at least one timestamp in the second set of timestamps is different from the timestamps in the first set of timestamps.

In an embodiment, the method 1500 may further include defining a constituent frame as one of the following: a rectangular region within a frame comprising one or more other constituent frames; a frame within two or more adjacent frames, in output order, that correspond to same display timestamp; or a first frame in an access unit that also comprises one or more other frames originating from the same source frame as the first frame, wherein the first frame and the one or more other frames reside in different scalability layers

The method 1500 may be performed with an apparatus described herein, for example, the apparatus 50, 100, 1400, and the like.

FIG. 16 is an example method 1600 to implement the examples described herein, in accordance with another embodiment. At 1602, the method 1600 includes decoding a bitstream into a decoded frame sequence. At 1604, the method 1600 includes identifying a first constituent frame sequence and a second constituent frame sequence from the decoded frame sequence, where the first constituent frame sequence corresponds to a first set of timestamps, the second constituent frame sequence corresponds to a second set of timestamps, the second set of timestamps at least partially differs from the first set of timestamps. At 1606, the method 1600 includes fusing the first constituent frame sequence and the second constituent frame sequence into a composed video sequence corresponding to a union of the first and second sets of timestamps.

In an embodiment, the method 1600 may further include upsampling a frame rate for the first constituent frame sequence.

In an embodiment, the method 1600 may further include: identifying one or more ROIs to be generated; and initializing a composed frame to be an upsampled content frame carried in the second constituent frame, and perform the following for each ROI to be generated: frame rate upsampling to create a generated ROI; and update the composed frame by overlaying the generated ROI on top of the composed frame.

The method 1600 may be performed with an apparatus described herein, for example, the apparatus 50, 100, 1400, and the like.

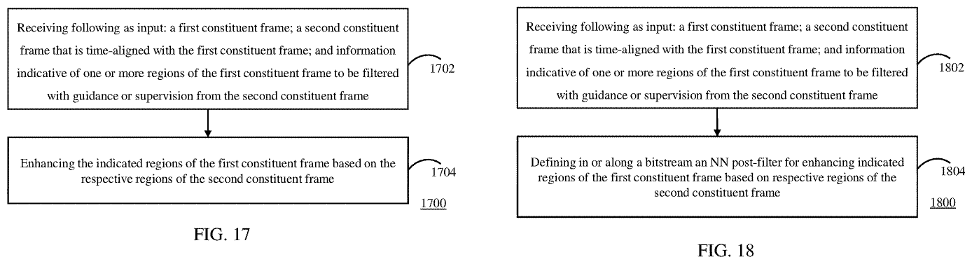

FIG. 17 is an example method 1700 to implement the examples described herein, in accordance with yet another embodiment. At 1702, the method 1700 includes receiving following as input: a first constituent frame; a second constituent frame that is time-aligned with the first constituent frame; and information indicative of one or more regions of the first constituent frame to be filtered with guidance or supervision from the second constituent frame. At 1704, the method 1700 includes enhancing the indicated regions of the first constituent frame based on the respective regions of the second constituent frame.

The method 1800 may be performed with an apparatus described herein, for example, the apparatus 50, 100, 1400, and the like.

FIG. 18 is an example method 1800 to implement the examples described herein, in accordance with yet another embodiment. At 1802, the method 1800 includes receiving following as input: a first constituent frame; a second constituent frame that is time-aligned with the first constituent frame; and information indicative of one or more regions of the first constituent frame to be filtered with guidance or supervision from the second constituent frame. At 1804, the method 1800 includes defining in or along a bitstream an NN post-filter for enhancing indicated regions of the first constituent frame based on respective regions of the second constituent frame.

In an embodiment, the method 1800 may further include indicating in or along the bitstream which pairs of the first and second constituent frames the NN post-filter is to be used for or is to be activated.

In an embodiment, the method 1800 may further include defining an indication message to include a flag for indicating a filtering purpose.

The method 1800 may be performed with an apparatus described herein, for example, the apparatus 50, 100, 1400, and the like.

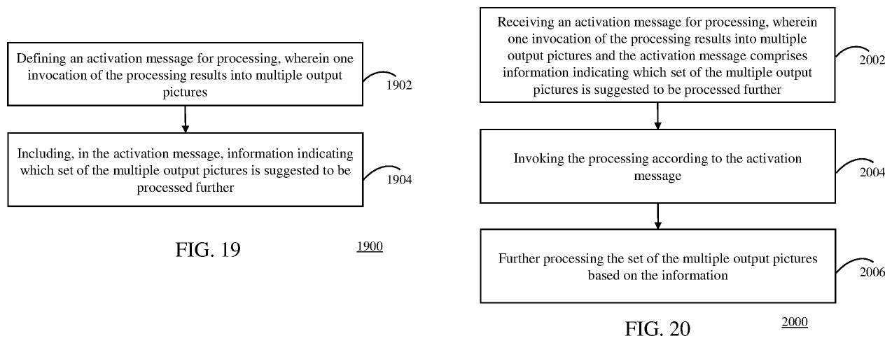

FIG. 19 is an example method 1900 to implement the examples described herein, in accordance with still another embodiment. At 1902, the method 1900 includes defining an activation message for processing, wherein one invocation of the processing results into multiple output pictures. At 1904, the method 1900 includes including, in the activation message, information indicating which set of the multiple output pictures is suggested to be processed further.

In an embodiment, the method 1900 may further include signaling the activation message to a decoder.

In an embodiment, the processing comprises a filtering process of one or more reconstructed pictures

In an embodiment, the activation message comprises a neural network post filter activation (NNPFA) supplemental enhancement information (SEI) message

The method 1900 may be performed with an apparatus described herein, for example, the apparatus 50, 100, 1400, and the like.

FIG. 20 is an example method 2000 to implement the examples described herein, in accordance with still another embodiment. At 2002, the method 2000 includes receiving an activation message for processing, where one invocation of the processing results into multiple output pictures. The activation message comprises information indicating which set of the multiple output pictures is suggested to be processed further. At 2004, the method 2000 includes invoking the processing according to the activation message. At 2006, the method 2000 includes further processing the set of the multiple output pictures based on the information.

In an embodiment, the processing comprises a filtering process of one or more reconstructed pictures

The method 2000 may be performed with an apparatus described herein, for example, the apparatus 50, 100, 1400, and the like.

Referring to FIG. 21, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, for example, as part of a RU, but some examples of this may have the transceiver 160 as part of a separate RU, for example, under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, for example, link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (for example, a central unit (CU), gNB-CU) of the RAN node 170 to the RRH/DU 195. Reference 198 also indicates those suitable network link(s).

It is noted that description herein indicates that ‘cells’ perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (for example, the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, for example, an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured to implement asymmetric frame rate coding of regions of interest. Computer program code 173 may also be configured to implement asymmetric frame rate coding of regions of interest.

As described above, FIGS. 15 to 20 include flowcharts of an apparatus (e.g. 50, 100, or 1400), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 58, 125, or 1404) of an apparatus employing an embodiment of the present invention and executed by processing circuitry (e.g. 56, 120, or 1402) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 15 to 20. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

Circuitry or Circuit: As used in this application, the term “circuitry” or “circuit” may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory (ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

1-74. (canceled)

75. An apparatus comprising at least one processor; and at least one memory storing instructions that, when executed by the at least one processor, cause the apparatus at least to perform:
defining an activation message for processing, wherein an invocation of the processing results into multiple output pictures; and
including, in the activation message, information indicating which set of the multiple output pictures is suggested to be processed further.

76. The apparatus of claim 75, wherein the apparatus is further caused to perform: signaling the activation message to a decoder.

77. The apparatus of claim 75, wherein the processing comprises a filtering process of one or more reconstructed pictures.

78. The apparatus of claim 75, wherein the activation message comprises a neural network post filter activation (NNPFA) supplemental enhancement information (SEI) message.

79. An apparatus comprising at least one processor; and at least one memory storing instructions that, when executed by the at least one processor, cause the apparatus at least to perform:
receiving an activation message for processing, wherein an invocation of the processing results into multiple output pictures and the activation message comprises information indicating which set of the multiple output pictures is suggested to be processed further;
invoking the processing according to the activation message; and
further processing the set of the multiple output pictures based on the information.

80. The apparatus of claim 79, wherein the processing comprises a filtering process of one or more reconstructed pictures.

81. The apparatus of claim 79, wherein the activation message comprises a neural network post filter activation (NNPFA) supplemental enhancement information (SEI) message.

82. A method comprising:
defining an activation message for processing, wherein an invocation of the processing results into multiple output pictures; and
including, in the activation message, information indicating which set of the multiple output pictures is suggested to be processed further.

83. The method of claim 82 further comprising signaling the activation message to a decoder.

84. The method of claim 82, wherein the processing comprises a filtering process of one or more reconstructed pictures.

85. The method of claim 82, wherein the activation message comprises a neural network post filter activation (NNPFA) supplemental enhancement information (SEI) message.

86. A method comprising:
receiving an activation message for processing, wherein an invocation of the processing results into multiple output pictures and the activation message comprises information indicating which set of the multiple output pictures is suggested to be processed further;
invoking the processing according to the activation message; and
further processing the set of the multiple output pictures based on the information.

87. The method of claim 86, wherein the processing comprises a filtering process of one or more reconstructed pictures.

88. The method of claim 86, wherein the activation message comprises a neural network post filter activation (NNPFA) supplemental enhancement information (SEI) message.
